(19) United States
(12) Patent Application Publication
(10) Pub. No.: US 2025/0168869 A1
(43) Pub. Date: May 22, 2025

(54) ENERGY TRANSFER CONFIGURATION FOR SIDELINK COMMUNICATIONS

(71) Applicant: QUALCOMM INCORPORATED, San Diego, CA (US)

(72) Inventors: Ahmed Elshafie, San Diego, CA (US); Alexandros Manolakos, Athens (GR); Kianoush Hosseini, San Diego, CA (US); Yuchul Kim, San Diego, CA (US)

(21) Appl. No.: 18/842,356

(22) PCT Filed: Mar. 28, 2023
(86) PCT No.: PCT/US2023/065062

§ 371 Date: Aug. 28, 2024

(30) Foreign Application Priority Data
May 6, 2022 (GR) 20220100376

(51) Int. Cl. H04W 72/40; H02J 50/00; H02J 50/20; H02J 50/80; H04W 72/25

(52) U.S. Cl. CPC H04W 72/40; H02J 50/001; H02J 50/20; H02J 50/80; H04W 72/25

(57) ABSTRACT

Methods, systems, and devices for wireless communications are described that provide for configuration of sidelink resource pools that may include energy transfer resources configured for energy harvesting. A sidelink device such as a user equipment (UE) may receive control signaling for a sidelink communications resource pool. The control signaling may include an energy harvesting configuration for at least a portion of the sidelink communications resource pool, where the energy harvesting configuration indicates one or more of a waveform for energy harvesting transmissions or an energy transfer level of the energy harvesting transmissions. The UE may determine, based at least in part on the energy harvesting configuration, one or more energy harvesting parameters for communications with a second UE via the sidelink communications resource pool, and may communicate with the second UE based at least in part on the one or more energy harvesting parameters.

### CROSS REFERENCES

The present application is a 371 national stage filing of International PCT Application No. PCT/US2023/065062 by Elshafie et al. entitled “ENERGY TRANSFER CONFIGURATION FOR SIDELINK COMMUNICATIONS,” filed Mar. 28, 2023; and claims priority to Greek patent application No. 20220100376 by Elshafie et al. entitled “ENERGY TRANSFER CONFIGURATION FOR SIDELINK COMMUNICATIONS,” filed May 6, 2022, each of which is assigned to the assignee hereof, and each of which is expressly incorporated by reference in its entirety herein.

### FIELD OF TECHNOLOGY

The following relates to wireless communications, including energy transfer configuration for sidelink communications.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM).

A wireless multiple-access communications system may include one or more base stations or one or more network access nodes, each simultaneously supporting communication for multiple communication devices, which may be known as user equipment (UE). In some wireless communications systems, a UE may be configured to harvest energy from one or more signals received from another device (e.g., another UE or a network entity). Improved techniques for facilitating energy transfer in a wireless communications system may be desirable.

### SUMMARY

The described techniques relate to improved methods, systems, devices, and apparatuses that support energy transfer configuration for sidelink communications. For example, the described techniques provide for configuration of sidelink resource pools that may include resources configured for energy transfer. In some cases, a UE may receive control signaling (e.g., from another UE or from a network entity) for a sidelink communications resource pool. The control signaling may include an energy harvesting configuration for at least a portion of the sidelink communications resource pool configured for energy transfer, where the energy harvesting configuration indicates one or more of a waveform for energy harvesting transmissions or an energy transfer level of the energy harvesting transmissions. The UE may determine, based at least in part on the energy harvesting configuration, one or more energy harvesting parameters for communications with a second UE via the sidelink communications resource pool, and may communicate with the second UE based at least in part on the one or more energy harvesting parameters.

A method for wireless communication at a first user equipment (UE) is described. The method may include receiving control signaling for a sidelink communications resource pool, the control signaling including an energy harvesting configuration for at least a portion of the sidelink communications resource pool, the energy harvesting configuration indicting one or more of a waveform for energy harvesting transmissions or an energy transfer level of the energy harvesting transmissions, determining, based on the energy harvesting configuration, one or more energy harvesting parameters for communications with a second UE via the sidelink communications resource pool, and communicating with the second UE based on the one or more energy harvesting parameters.

An apparatus for wireless communication at a first UE is described. The apparatus may include at least one processor, and memory coupled to the at least one processor, the memory storing instructions executable by the at least one processor to cause the apparatus to receive control signaling for a sidelink communications resource pool, the control signaling including an energy harvesting configuration for at least a portion of the sidelink communications resource pool, the energy harvesting configuration indicting one or more of a waveform for energy harvesting transmissions or an energy transfer level of the energy harvesting transmissions, determine, based on the energy harvesting configuration, one or more energy harvesting parameters for communications with a second UE via the sidelink communications resource pool, and communicate with the second UE based on the one or more energy harvesting parameters.

Another apparatus for wireless communication at a first UE is described. The apparatus may include means for receiving control signaling for a sidelink communications resource pool, the control signaling including an energy harvesting configuration for at least a portion of the sidelink communications resource pool, the energy harvesting configuration indicting one or more of a waveform for energy harvesting transmissions or an energy transfer level of the energy harvesting transmissions, means for determining, based on the energy harvesting configuration, one or more energy harvesting parameters for communications with a second UE via the sidelink communications resource pool, and means for communicating with the second UE based on the one or more energy harvesting parameters.

A non-transitory computer-readable medium storing code for wireless communication at a first UE is described. The code may include instructions executable by at least one processor to receive control signaling for a sidelink communications resource pool, the control signaling including an energy harvesting configuration for at least a portion of the sidelink communications resource pool, the energy harvesting configuration indicting one or more of a waveform for energy harvesting transmissions or an energy transfer level of the energy harvesting transmissions, determine, based on the energy harvesting configuration, one or more energy harvesting parameters for communications with a second UE via the sidelink communications resource pool, and communicate with the second UE based on the one or more energy harvesting parameters.

In some examples of the method, apparatuses, and non-transitory computer-readable medium described herein, the receiving the control signaling may include operations, features, means, or instructions for receiving an indication that a first waveform of two or more different energy harvesting waveforms is selected for energy harvesting, where the first waveform is selected based on a target amount of energy to be transferred in the energy harvesting transmissions.

In some examples of the method, apparatuses, and non-transitory computer-readable medium described herein, the receiving the control signaling may include operations, features, means, or instructions for receiving a first sidelink communications resource pool configuration for a first resource pool in which all available resources are allocated for the energy harvesting transmissions, or in which a portion of the available resources are allocated for the energy harvesting transmissions. In some examples of the method, apparatuses, and non-transitory computer-readable medium described herein, the control signaling for two or more sidelink communications resource pools is provided by a network entity that configures sidelink communications between the first UE and the second UE, and where at least one of the two or more sidelink communications resource pools includes the energy harvesting configuration. In some examples of the method, apparatuses, and non-transitory computer-readable medium described herein, the energy harvesting configuration indicates one or more of a charging rate associated with the energy harvesting transmissions, a waveform type of the energy harvesting transmissions, a portion of the sidelink communications resource pool that is allocated for the energy harvesting transmissions, or any combinations thereof. In some examples of the method, apparatuses, and non-transitory computer-readable medium described herein, the sidelink communications resource pool includes at least a first bandwidth part for the energy harvesting transmissions and a second bandwidth part for data communications, and where the first bandwidth part and second bandwidth part may have separately configured subcarrier spacing, frequency locations, or any combinations thereof.

In some examples of the method, apparatuses, and non-transitory computer-readable medium described herein, the receiving the control signaling may include operations, features, means, or instructions for receiving two or more energy harvesting configurations for the sidelink communications resource pool in a first sidelink control information communication and receiving an indication of a selected energy harvesting configuration of the two or more energy harvesting configurations in a second sidelink control information communication, and where communications with the second UE are performed in accordance with the selected energy harvesting configuration. In some examples of the method, apparatuses, and non-transitory computer-readable medium described herein, the sidelink communications resource pool may be a first sidelink communications resource pool having the energy harvesting configuration, and the control signaling is received in a second sidelink communications resource pool that is different than the first sidelink communications resource pool. In some examples of the method, apparatuses, and non-transitory computer-readable medium described herein, the first sidelink communications resource pool provides resources for the energy harvesting transmissions only, without resources for automatic gain control. In some examples of the method, apparatuses, and non-transitory computer-readable medium described herein, the control signaling may be received prior to the energy harvesting transmissions, and indicates resources of the sidelink communications resource pool that are reserved for the energy harvesting transmissions.

In some examples of the method, apparatuses, and non-transitory computer-readable medium described herein, the receiving may include operations, features, means, or instructions for receiving energy-harvesting-specific sidelink control information that indicates the waveform for the energy harvesting transmissions and the energy transfer level for the energy harvesting transmissions. Some examples of the method, apparatuses, and non-transitory computer-readable medium described herein may further include operations, features, means, or instructions for selecting a first energy harvesting configuration from a set of multiple energy harvesting configurations provided by the control signaling and transmitting an indication to the second UE of the selected first energy harvesting configuration. Some examples of the method, apparatuses, and non-transitory computer-readable medium described herein may further include operations, features, means, or instructions for adjusting a transmit power for the energy harvesting transmissions based on a number of receiving UEs that are to receive the energy harvesting transmissions and transmitting the energy harvesting transmissions in the sidelink communications resource pool.

In some examples of the method, apparatuses, and non-transitory computer-readable medium described herein, the sidelink communications resource pool may be configured for both data transmissions and the energy harvesting transmissions, and where the energy harvesting configuration indicates one or more time switching parameters or power splitting parameters for the data transmissions and the energy harvesting transmissions. In some examples of the method, apparatuses, and non-transitory computer-readable medium described herein, the sidelink communications resource pool may be configured for only the energy harvesting transmissions, and where the energy harvesting configuration is provided in a first sidelink control channel transmission that is nonspecific to energy harvesting and a second sidelink shared channel transmission that provides one or more energy harvesting parameters, or the energy harvesting configuration is provided in a first sidelink control channel transmission that is specific to energy harvesting.

In some examples of the method, apparatuses, and non-transitory computer-readable medium described herein, the sidelink communications resource pool includes a first subset of resources for data transmissions and a second subset of resources for the energy harvesting transmissions, and where each of the first subset of resources and the second subset of resources have separate channel sensing parameters, channel busy ratio (CBR) configurations, power control configurations, or any combinations thereof. In some examples of the method, apparatuses, and non-transitory computer-readable medium described herein, the sidelink communications resource pool includes resources for the energy harvesting transmissions that may be scheduled by a network entity or by the first UE. In some examples of the method, apparatuses, and non-transitory computer-readable medium described herein, the energy harvesting transmissions may be wideband transmissions that span frequency resources of one sidelink communications resource pool or two or more frequency division multiplexed sidelink communications resource pools.

In some examples of the method, apparatuses, and non-transitory computer-readable medium described herein, the energy harvesting transmissions use resources that at least partially overlap in time and frequency with one or more data transmissions, and where the energy harvesting configuration indicates one or more parameters for interference mitigation of the energy harvesting transmissions prior to decoding of the one or more data transmissions. In some examples of the method, apparatuses, and non-transitory computer-readable medium described herein, one or more resources within the sidelink communications resource pool are selected for the energy harvesting transmissions by the first UE that receives the energy harvesting transmissions, by the second UE that transmits the energy harvesting transmissions, or by a network entity that configures the sidelink communications resource pool.

A method for wireless communication at a network entity is described. The method may include identifying at least a first UE and a second UE for sidelink communications and transmitting control signaling to at least the first UE and the second UE for a sidelink communications resource pool, the control signaling including one or more energy harvesting configurations that are available for at least a portion of the sidelink communications resource pool, the one or more energy harvesting configurations indicting one or more of a waveform for energy harvesting transmissions or an energy transfer level of the energy harvesting transmissions.

An apparatus for wireless communication at a network entity is described. The apparatus may include at least one processor, and memory coupled to the at least one processor, the memory storing instructions executable by the at least one processor to cause the apparatus to identify at least a first UE and a second UE for sidelink communications and transmit control signaling to at least the first UE and the second UE for a sidelink communications resource pool, the control signaling including one or more energy harvesting configurations that are available for at least a portion of the sidelink communications resource pool, the one or more energy harvesting configurations indicting one or more of a waveform for energy harvesting transmissions or an energy transfer level of the energy harvesting transmissions.

Another apparatus for wireless communication at a network entity is described. The apparatus may include means for identifying at least a first UE and a second UE for sidelink communications and means for transmitting control signaling to at least the first UE and the second UE for a sidelink communications resource pool, the control signaling including one or more energy harvesting configurations that are available for at least a portion of the sidelink communications resource pool, the one or more energy harvesting configurations indicting one or more of a waveform for energy harvesting transmissions or an energy transfer level of the energy harvesting transmissions.

A non-transitory computer-readable medium storing code for wireless communication at a network entity is described. The code may include instructions executable by at least one processor to identify at least a first UE and a second UE for sidelink communications and transmit control signaling to at least the first UE and the second UE for a sidelink communications resource pool, the control signaling including one or more energy harvesting configurations that are available for at least a portion of the sidelink communications resource pool, the one or more energy harvesting configurations indicting one or more of a waveform for energy harvesting transmissions or an energy transfer level of the energy harvesting transmissions.

In some examples of the method, apparatuses, and non-transitory computer-readable medium described herein, the one or more energy harvesting configurations include two or more waveforms for the energy harvesting transmissions that are selectable based on a target amount of energy to be transferred in the energy harvesting transmissions. In some examples of the method, apparatuses, and non-transitory computer-readable medium described herein, the sidelink communications resource pool includes a set of sidelink resources, and where all resources of the set of sidelink resources are allocated for the energy harvesting transmissions or a subset of the set of sidelink resources are allocated for the energy harvesting transmissions. In some examples of the method, apparatuses, and non-transitory computer-readable medium described herein, each of the one or more energy harvesting configurations indicates one or more of a charging rate, a waveform type of the energy harvesting transmissions, a portion of the sidelink communications resource pool that are allocated for the energy harvesting transmissions, or any combinations thereof.

### BRIEF DESCRIPTION OF THE DRAWINGS

FIG. 1 illustrates an example of a wireless communications system that supports energy transfer configuration for sidelink communications in accordance with one or more aspects of the present disclosure.

FIG. 2 illustrates an example of a wireless communications system that supports energy transfer configuration for sidelink communications in accordance with one or more aspects of the present disclosure.

FIG. 3 illustrates an example of different energy harvesting schemes in accordance with one or more aspects of the present disclosure.

FIGS. 4 through 6 illustrate examples of sidelink resource pool configurations that support energy transfer configuration for sidelink communications in accordance with one or more aspects of the present disclosure.

FIG. 7 illustrates an example of wideband sidelink resources that support energy transfer configuration for sidelink communications in accordance with one or more aspects of the present disclosure.

FIG. 8 illustrates an example of a process flow that supports energy transfer configuration for sidelink communications in accordance with one or more aspects of the present disclosure.

FIGS. 9 and 10 show block diagrams of devices that support energy transfer configuration for sidelink communications in accordance with one or more aspects of the present disclosure.

FIG. 11 shows a block diagram of a communications manager that supports energy transfer configuration for sidelink communications in accordance with one or more aspects of the present disclosure.

FIG. 12 shows a diagram of a system including a device that supports energy transfer configuration for sidelink communications in accordance with one or more aspects of the present disclosure.

FIGS. 13 and 14 show block diagrams of devices that support energy transfer configuration for sidelink communications in accordance with one or more aspects of the present disclosure.

FIG. 15 shows a block diagram of a communications manager that supports energy transfer configuration for sidelink communications in accordance with one or more aspects of the present disclosure.

FIG. 16 shows a diagram of a system including a device that supports energy transfer configuration for sidelink communications in accordance with one or more aspects of the present disclosure.

FIGS. 17 through 23 show flowcharts illustrating methods that support energy transfer configuration for sidelink communications in accordance with one or more aspects of the present disclosure.

### DETAILED DESCRIPTION

Some wireless communications systems may support wireless devices (e.g., user equipment (UE)) that may be capable of obtaining all or some operating power through energy harvesting techniques. For example, some wireless communications systems may support devices that have an energy harvesting mode where some or all of the operating power of a device may be provided wirelessly. In some cases, an energy harvesting circuit at a wireless device (e.g., a UE) may receive energy harvesting signals from another transmitting device (e.g., a network node such as a base station, another UE, or some other transmitting device), and may draw energy from the signals for charging. Such energy harvesting may enable prolonged battery lifetime of certain devices (e.g., Internet of Things (IoT) devices or wearable devices) and in some cases may be used as incentives for devices to cooperate and relay other UEs/wearables signals as well as allowing recycling of network energy so that the network is more self-sustainable (e.g., at least part of the RF energy used in the network can be exploited and harvested by the network users). Further, in some cases, devices may operate using sidelink communications in which devices communicate directly with other like devices (e.g., multiple UEs that communicate directly) where some or all of the communications are not routed through another network node.

In some cases, sidelink communications may be configured in which a set of frequency resources (e.g., a bandwidth part (BWP) of an operating frequency bandwidth) may contain one or more receiving and transmitting resource pools, and physical layer channels may be configured per resource pool. Devices that use sidelink communications may receive configuration information that indicates parameters associated with one or more resource pools, and communicate in accordance with such configuration information. In some cases, resources for sidelink communications may be provided based on different resource allocation modes, such as a first mode (e.g., Mode 1) in which sidelink resources are scheduled by a network entity (e.g., a base station assigns resources for sidelink transmission, such as dynamic allocation via downlink control information or configured transmissions), and a second mode where a sidelink device may autonomously select sidelink resources from one or more configured sidelink resource pools (e.g., based on a channel sensing mechanism).

In accordance with various aspects discussed herein, energy transfer and harvesting may be implemented for sidelink communications. Such energy transfer and harvesting (e.g., through accumulation of energy over time) may provide all or a portion of energy to be used in one or more tasks such as data decoding, data reception, data encoding, data transmission, or operating some filters. Energy transfer may refer to transfer of energy by a transmitting device that may be harvested at one or more receiving devices, and energy harvesting may refer to the harvesting of energy at such receiving devices. Techniques for energy transfer and energy harvesting are generally referred to as energy harvesting techniques, with energy harvesting techniques of various aspects applied at transmitting devices for energy transfer and applied at receiving devices for energy harvesting. In some cases, one or more sidelink resource pools may be configured for energy harvesting procedures. For example, a serving network device (e.g., a serving base station or primary UE) in a sidelink system may configure a resource pool or a portion of a resource pool for energy harvesting, where the configuration indicates energy harvesting parameters. Such energy harvesting parameters may include, for example, an energy harvesting waveform (e.g., a sounding reference signal (SRS) waveform, a channel state information reference signal (CSI-RS) waveform, or a new waveform or reference signal), a charging rate, a portion of the resource pool used for energy harvesting, or any combinations thereof. In some cases, the energy harvesting resources may include one or more BWPs in a resource pool that are outside of other BWPs for data transfer, and may have their own subcarrier spacing (SCS), frequency location, bandwidth, or any combinations thereof.

In some cases, the sidelink energy harvesting configuration may be provided in sidelink control information (SCI), such as SCI that reserves resources (e.g., SCI-1), or SCI that indicates a configuration of multiple available configurations (e.g., SCI-2). In cases where a resource pool is exclusively for energy harvesting, configuration information may be provided in a different resource pool (e.g., in SCI of a different resource pool), and the energy harvesting resource pool may have all gaps and symbols used for automatic gain control (AGC) removed. In some cases, SCI may indicate reserved/scheduled energy harvesting resources using one or more new fields, in an associated energy harvesting SCI format, or any combinations thereof. Such techniques may provide for efficient indication of energy harvesting resources and associated parameters, which allow for one or more devices to obtain at least a portion of their power to enable communications or prolong operating/battery life of the one or more devices.

Aspects of the disclosure are initially described in the context of wireless communications systems. Examples of processes and signaling exchanges that support power control configuration and signaling are then described. Aspects of the disclosure are further illustrated by and described with reference to apparatus diagrams, system diagrams, and flowcharts that relate to energy transfer configuration for sidelink communications.

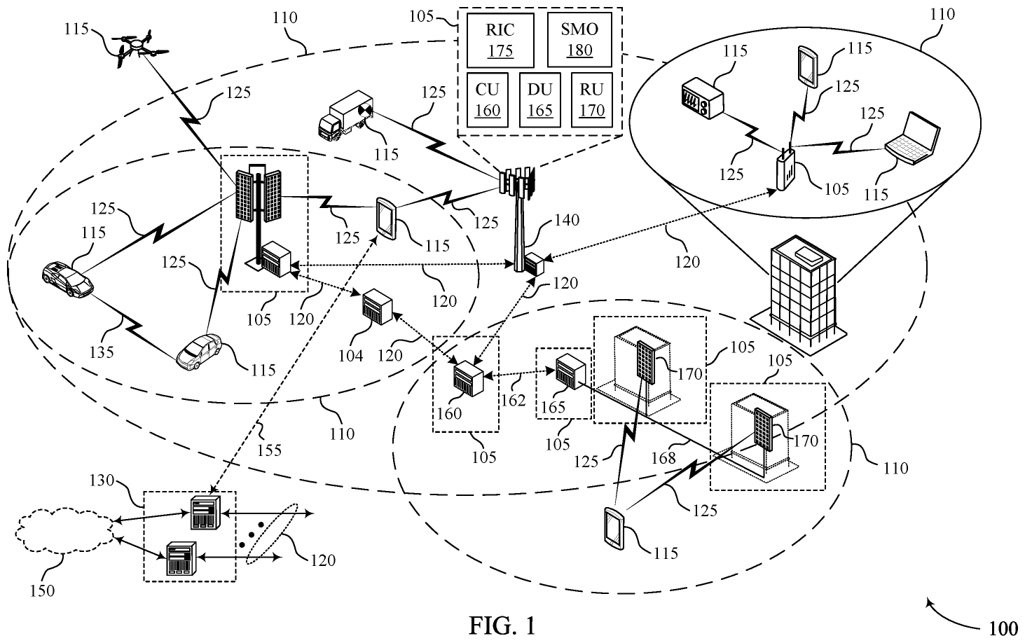

FIG. 1 illustrates an example of a wireless communications system 100 that supports energy transfer configuration for sidelink communications in accordance with one or more aspects of the present disclosure. The wireless communications system 100 may include one or more network entities 105, one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In some examples, network entities 105 and UEs 115 may wirelessly communicate via one or more communication links 125. For example, a network entity 105 may support a coverage area 110 (e.g., a geographic coverage area) over which the UEs 115 and the network entity 105 may establish one or more communication links 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be able to communicate with various types of devices, such as other UEs 115 or network entities 105, as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with the core network 130, or with one another, or both. For example, network entities 105 may communicate with the core network 130 via one or more backhaul communication links 120 (e.g., in accordance with an S1, N2, N3, or other interface protocol). In some examples, network entities 105 may communicate with one another over a backhaul communication link 120 (e.g., in accordance with an X2, Xn, or other interface protocol) either directly (e.g., directly between network entities 105) or indirectly (e.g., via a core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication links 120, midhaul communication links 162, or fronthaul communication links 168 may be or include one or more wired links (e.g., an electrical link, an optical fiber link), one or more wireless links (e.g., a radio link, a wireless optical link), among other examples or various combinations thereof. A UE 115 may communicate with the core network 130 through a communication link 155.

One or more of the network entities 105 described herein may include or may be referred to as a base station 140 (e.g., a base transceiver station, a radio base station, an access point, a radio transceiver, a NodeB, an eNodeB (eNB), a next-generation NodeB or a giga-NodeB (either of which may be referred to as a gNB), a next-generation eNB (ng-eNB), a Home NodeB, a Home eNodeB, or other suitable terminology). A network entity 105 (e.g., a base station 140) may be implemented in an aggregated or monolithic base station architecture, or alternatively, in a disaggregated base station architecture. For example, a network entity 105 may include one or more of a central unit (CU) 160, a distributed unit (DU) 165, a radio unit (RU) 170, a Radio Access Network (RAN) Intelligent Controller (RIC) 175 (e.g., a Near-Real Time RIC (Near-RT RIC), a Non-Real Time RIC (Non-RT RIC), a Service Management and Orchestration (SMO) 180 system, or any combination thereof. An RU 170 may also be referred to as a radio head, a smart radio head, a remote radio head (RRH), a remote radio unit (RRU), or a transmission/reception point (TRP). One or more components of the network entities 105 of a disaggregated RAN may be co-located, or one or more components of the network entities 105 may be located in distributed locations.

The split of functionality between a CU 160, a DU 165, and an RU 175 is flexible and may support different functionalities depending upon which functions (e.g., network layer functions, protocol layer functions, baseband functions, radio frequency functions, and any combinations thereof) are performed at a CU 160, a DU 165, or an RU 175. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaption protocol (SDAP), Packet Data Convergence Protocol (PDCP)). The CU 160 may be connected to one or more DUs 165 or RUs 170, and the one or more DUs 165 or RUs 170 may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or more RUs 170). In some cases, a functional split between a CU 160 and a DU 165, or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to one or more DUs 165 via a midhaul communication link 162 (e.g., F1, F1-c, F1-u), and a DU 165 may be connected to one or more RUs 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities 105 that are in communication over such communication links.

In wireless communications systems (e.g., wireless communications system 100), infrastructure and spectral resources for radio access may support wireless backhaul link capabilities to supplement wired backhaul connections, providing an integrated access backhaul (IAB) network architecture (e.g., to a core network 130). In some cases, in an IAB network, one or more network entities 105 (e.g., IAB nodes 104) may be partially controlled by each other. One or more IAB nodes 104 may be referred to as a donor entity or an IAB donor. One or more DUs 165 (e.g., one or more RUs 170) may be partially controlled by CUs 160 associated with a donor network entity 105 (e.g., a donor base station 140). The one or more donor network entities 105 (e.g., IAB donors) may be in communication with one or more additional network entities 105 (e.g., IAB nodes 104) via supported access and backhaul links (e.g., backhaul communication links 120). IAB nodes 104 may include an IAB mobile termination (IAB-MT) controlled (e.g., scheduled) by DUs 165 of a coupled IAB donor. An IAB-MT may include an independent set of antennas for relay of communications with UEs 115, or may share the same antennas (e.g., of an RU 170) of an IAB node 104 used for access via the DU 165 of the IAB node 104 (e.g., referred to as virtual IAB-MT (vIAB-MT)). In some examples, the IAB nodes 104 may include DUs 165 that support communication links with additional entities (e.g., IAB nodes 104, UEs 115) within the relay chain or configuration of the access network (e.g., downstream). In such cases, one or more components of the disaggregated RAN architecture (e.g., one or more IAB nodes 104 or components of IAB nodes 104) may be configured to operate according to the techniques described herein.

In the case of the techniques described herein applied in the context of a disaggregated RAN architecture, one or more components of the disaggregated RAN architecture may be configured to support energy transfer configuration for sidelink communications as described herein. For example, some operations described as being performed by a UE 115 or a network entity 105 (e.g., a base station 140) may additionally, or alternatively, be performed by one or more components of the disaggregated RAN architecture (e.g., IAB nodes 104, DUs 165, CUs 160, RUs 170, RIC 170, SMO 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a multimedia/entertainment device (e.g., a radio, a MP3 player, or a video device), a camera, a gaming device, a navigation/positioning device (e.g., GNSS (global navigation satellite system) devices based on, for example, GPS (global positioning system), Beidou, GLONASS, or Galileo, or a terrestrial-based device), a tablet computer, a laptop computer, a netbook, a smartbook, a personal computer, a smart device, a wearable device (e.g., a smart watch, smart clothing, smart glasses, virtual reality goggles, a smart wristband, smart jewelry (e.g., a smart ring, a smart bracelet)), a drone, a robot/robotic device, a vehicle, a vehicular device, a meter (e.g., parking meter, electric meter, gas meter, water meter), a monitor, a gas pump, an appliance (e.g., kitchen appliance, washing machine, dryer), a location tag, a medical/healthcare device, an implant, a sensor/actuator, a display, or any other suitable device configured to communicate via a wireless or wired medium. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, or vehicles, meters, among other examples.

The UEs 115 described herein may be able to communicate with various types of devices, such as other UEs 115 that may sometimes act as relays as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via one or more communication links 125 (e.g., an access link) over one or more carriers. The term “carrier” may refer to a set of radio frequency spectrum resources having a defined physical layer structure for supporting the communication links 125. For example, a carrier used for a communication link 125 may include a portion of a radio frequency spectrum band (e.g., a bandwidth part (BWP)) that is operated according to one or more physical layer channels for a given radio access technology (e.g., LTE, LTE-A, LTE-A Pro, NR). Each physical layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting.” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities 105).

In some examples, such as in a carrier aggregation configuration, a carrier may also have acquisition signaling or control signaling that coordinates operations for other carriers. A carrier may be associated with a frequency channel (e.g., an evolved universal mobile telecommunication system terrestrial radio access (E-UTRA) absolute radio frequency channel number (EARFCN)) and may be positioned according to a channel raster for discovery by the UEs 115. A carrier may be operated in a standalone mode, in which case initial acquisition and connection may be conducted by the UEs 115 via the carrier, or the carrier may be operated in a non-standalone mode, in which case a connection is anchored using a different carrier (e.g., of the same or a different radio access technology).

The communication links 125 shown in the wireless communications system 100 may include downlink transmissions (e.g., forward link transmissions) from a network entity 105 to a UE 115, uplink transmissions (e.g., return link transmissions) from a UE 115 to a network entity 105, or both, among other configurations of transmissions. Carriers may carry downlink or uplink communications (e.g., in an FDD mode) or may be configured to carry downlink and uplink communications (e.g., in a TDD mode).

A carrier may be associated with a particular bandwidth of the radio frequency spectrum and, in some examples, the carrier bandwidth may be referred to as a “system bandwidth” of the carrier or the wireless communications system 100. For example, the carrier bandwidth may be one of a set of bandwidths for carriers of a particular radio access technology (e.g., 1.4, 3, 5, 10, 15, 20, 40, or 80 megahertz (MHz)). Devices of the wireless communications system 100 (e.g., the network entities 105, the UEs 115, or both) may have hardware configurations that support communications over a particular carrier bandwidth or may be configurable to support communications over one of a set of carrier bandwidths. In some examples, the wireless communications system 100 may include network entities 105 or UEs 115 that support concurrent communications via carriers associated with multiple carrier bandwidths. In some examples, each served UE 115 may be configured for operating over portions (e.g., a sub-band, a BWP) or all of a carrier bandwidth.

Signal waveforms transmitted over a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both) such that the more resource elements that a device receives and the higher the order of the modulation scheme, the higher the data rate may be for the device. A wireless communications resource may refer to a combination of a radio frequency spectrum resource, a time resource, and a spatial resource (e.g., a spatial layer, a beam), and the use of multiple spatial resources may increase the data rate or data integrity for communications with a UE 115.

One or more numerologies for a carrier may be supported, where a numerology may include a subcarrier spacing (Δf) and a cyclic prefix. A carrier may be divided into one or more BWPs having the same or different numerologies. In some examples, a UE 115 may be configured with multiple BWPs. In some examples, a single BWP for a carrier may be active at a given time and communications for the UE 115 may be restricted to one or more active BWPs.

The time intervals for the network entities 105 or the UEs 115 may be expressed in multiples of a basic time unit which may, for example, refer to a sampling period of Ts=1/(Δfₘₐₓ·N_{f}) seconds, where Δfₘₐₓ may represent the maximum supported subcarrier spacing, and N_{f} may represent the maximum supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems 100, a slot may further be divided into multiple mini-slots containing one or more symbols. Excluding the cyclic prefix, each symbol period may contain one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (STTIs)).

Physical channels may be multiplexed on a carrier according to various techniques. A physical control channel and a physical data channel may be multiplexed on a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific UE 115.

In some examples, a carrier may support multiple cells, and different cells may be configured according to different protocol types (e.g., MTC, narrow band IoT (NB-IoT), enhanced mobile broadband (eMBB)) that may provide access for different types of devices.

In some examples, a network entity 105 (e.g., a base station 140, an RU 170) may be movable and therefore provide communication coverage for a moving coverage area 110. In some examples, different coverage areas 110 associated with different technologies may overlap, but the different coverage areas 110 may be supported by the same network entity 105. In some other examples, the overlapping coverage areas 110 associated with different technologies may be supported by different network entities 105. The wireless communications system 100 may include, for example, a heterogeneous network in which different types of the network entities 105 provide coverage for various coverage areas 110 using the same or different radio access technologies.

Some UEs 115, such as MTC or IoT devices, may be low cost or low complexity devices and may provide for automated communication between machines (e.g., via Machine-to-Machine (M2M) communication). M2M communication or MTC may refer to data communication technologies that allow devices to communicate with one another or a network entity 105 (e.g., a base station 140) without human intervention. In some examples, M2M communication or MTC may include communications from devices that integrate sensors or meters to measure or capture information and relay such information to a central server or application program that makes use of the information or presents the information to humans interacting with the application program. Some UEs 115 may be designed to collect information or enable automated behavior of machines or other devices. Examples of applications for MTC devices include smart metering, inventory monitoring, water level monitoring, equipment monitoring, healthcare monitoring, wildlife monitoring, weather and geological event monitoring, fleet management and tracking, remote security sensing, physical access control, and transaction-based business charging. In an aspect, techniques disclosed herein may be applicable to MTC or IoT UEs. MTC or IoT UEs may include MTC/enhanced MTC (eMTC, also referred to as CAT-M, Cat M1) UEs, NB-IoT (also referred to as CAT NB1) UEs, as well as other types of UEs. eMTC and NB-IoT may refer to future technologies that may evolve from or may be based on these technologies. For example, eMTC may include FeMTC (further eMTC), eFeMTC (enhanced further eMTC), and mMTC (massive MTC), and NB-IoT may include eNB-IoT (enhanced NB-IoT), and FeNB-IoT (further enhanced NB-IoT).

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be able to communicate directly with other UEs 115 over a device-to-device (D2D) communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by or scheduled by the network entity 105. In some examples, one or more UEs 115 in such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to each of the other UEs 115 in the group. In some examples, a network entity 105 may facilitate the scheduling of resources for D2D communications. In some other examples, D2D communications may be carried out between the UEs 115 without the involvement of a network entity 105.

In some systems, a D2D communication link 135 may be an example of a communication channel, such as a sidelink communication channel, between vehicles (e.g., UEs 115). In some examples, vehicles may communicate using vehicle-to-everything (V2X) communications, vehicle-to-vehicle (V2V) communications, or some combination of these. A vehicle may signal information related to traffic conditions, signal scheduling, weather, safety, emergencies, or any other information relevant to a V2X system. In some examples, vehicles in a V2X system may communicate with roadside infrastructure, such as roadside units, or with the network via one or more network nodes (e.g., network entities 105, base stations 140, RUs 170) using vehicle-to-network (V2N) communications, or with both.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. The UHF waves may be blocked or redirected by buildings and environmental features, which may be referred to as clusters, but the waves may penetrate structures sufficiently for a macro cell to provide service to the UEs 115 located indoors. The transmission of UHF waves may be associated with smaller antennas and shorter ranges (e.g., less than 100 kilometers) compared to transmission using the smaller frequencies and longer waves of the high frequency (HF) or very high frequency (VHF) portion of the spectrum below: 300 MHz.

The wireless communications system 100 may utilize both licensed and unlicensed radio frequency spectrum bands. For example, the wireless communications system 100 may employ License Assisted Access (LAA), LTE-Unlicensed (LTE-U) radio access technology, or NR technology in an unlicensed band such as the 5 GHZ industrial, scientific, and medical (ISM) band. While operating in unlicensed radio frequency spectrum bands, devices such as the network entities 105 and the UEs 115 may employ carrier sensing for collision detection and avoidance. In some examples, operations in unlicensed bands may be based on a carrier aggregation configuration in conjunction with component carriers operating in a licensed band (e.g., LAA). Operations in unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located in diverse geographic locations. A network entity 105 may have an antenna array with a set of rows and columns of antenna ports that the network entity 105 may use to support beamforming of communications with a UE 115. Likewise, a UE 115 may have one or more antenna arrays that may support various MIMO or beamforming operations. Additionally, or alternatively, an antenna panel may support radio frequency beamforming for a signal transmitted via an antenna port.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating at particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

The wireless communications system 100 may be a packet-based network that operates according to a layered protocol stack. In the user plane, communications at the bearer or PDCP layer may be IP-based. An RLC layer may perform packet segmentation and reassembly to communicate over logical channels. A MAC layer may perform priority handling and multiplexing of logical channels into transport channels. The MAC layer may also use error detection techniques, error correction techniques, or both to support retransmissions at the MAC layer to improve link efficiency. In the control plane, the RRC protocol layer may provide establishment, configuration, and maintenance of an RRC connection between a UE 115 and a network entity 105 or a core network 130 supporting radio bearers for user plane data. At the PHY layer, transport channels may be mapped to physical channels.

In some cases, multiple UEs 115 may communication directly using sidelink resources, and techniques of various aspects described herein provide for configuration of sidelink resource pools that may include resources configured for energy harvesting. In some cases, a UE 115 may receive control signaling (e.g., from another UE 115 or from a network entity 105) for a sidelink communications resource pool. The control signaling may include an energy harvesting configuration for at least a portion of the sidelink communications resource pool, where the energy harvesting configuration indicates one or more of a waveform for energy harvesting transmissions or an energy transfer level of the energy harvesting transmissions. The UE 115 may determine, based at least in part on the energy harvesting configuration, one or more energy harvesting parameters for communications with a second UE 115 via the sidelink communications resource pool, and may communicate with the second UE 115 based at least in part on the one or more energy harvesting parameters.

In some cases, energy transfer via energy harvesting from one device in sidelink communications may can occur on a certain resource pools of a certain portion of one or more resource pools that are configured for sidelink communications. In addition, energy harvesting may be performed using one or multiple available types of waveforms, and a particular waveform selection may be based on charging rate, for example. Additionally, or alternatively, a waveform for energy harvesting may be selected based on how a reference signal is generated. In some cases, energy signals for energy harvesting may be SRS signals, CSI-RS signals, or defined waveform or reference signal. Further, such signals may have cyclic prefix OFDM (CP-OFDM) waveforms, or single carrier (SC) waveforms (e.g., discrete Fourier transform spread OFDM (DFT-s-OFDM) or SC quadrature amplitude multiplexing (QAM) waveforms). Additionally, digital generation or analog generation of energy signal may be performed, in the time domain or frequency domain. In some cases, the network entity 105-a may configure each resource pool with one or more of a charging rate (e.g., an energy transfer amount) when using the resource pool (e.g., an amount of energy that is capable of being received by a receiving device from a transmitting device using the resource pool), a waveform type such that each device is aware of which waveform is used (e.g., where for energy harvesting, processing is done in Analog Domain (AD)), a portion of the resource pool used for energy harvesting.

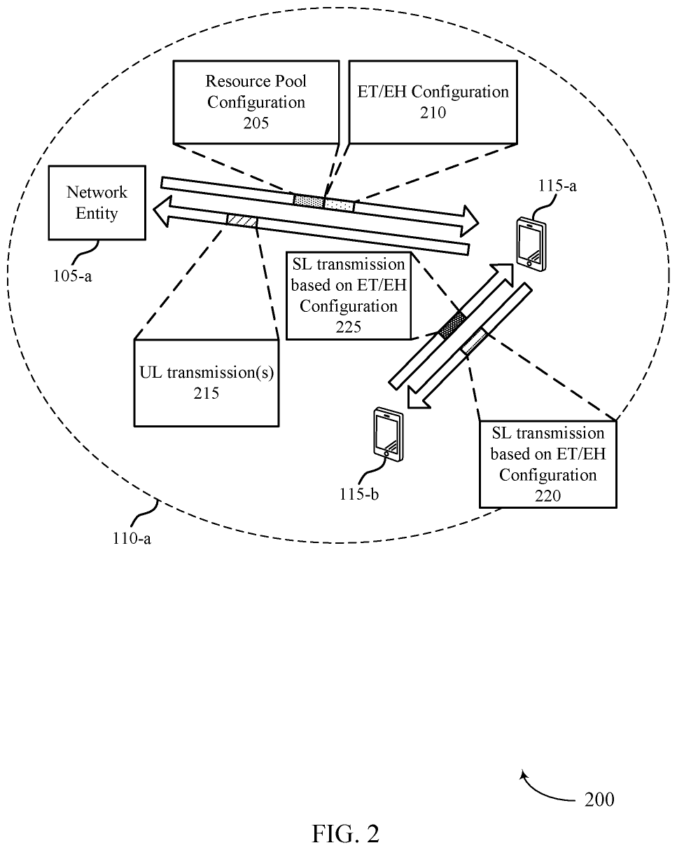

FIG. 2 illustrates an example of a wireless communications system 200 that supports energy transfer configuration for sidelink communications in accordance with one or more aspects of the present disclosure. The wireless communications system 200 includes a first UE 115-a and a second UE 115-b, which may be examples of UEs 115 described with reference to FIG. 1. The wireless communications system 200 also includes a network entity 105-a, which may be an example of a network entity 105 described with reference to FIG. 1. The network entity 105-a may provide communication coverage for UEs 115 in a geographic coverage area 110-a, which may be an example of a geographic coverage area 110 described with reference to FIG. 1. The wireless communications system 200 may support efficient techniques for sidelink resource pool configuration and indications of sidelink resource pools that provide for energy transfer and energy harvesting (ET/EH).

In this example, network entity 105-a may transmit a resource pool configuration 205 (e.g., an indication of various parameters for one or more sidelink resource pools) to the first UE 115-a. Further, the network entity 105-a may transmit an ET/EH configuration 210 to the first UE 115-a that indicates one or more ET/EH parameters. In some cases, the resource pool configuration 205 and the ET/EH configuration 210 may be transmitted to multiple UEs 115, including both the first UE 115-a and the second UE 115-b. In other cases, the resource pool configuration 205 and the ET/EH configuration 210 may be transmitted to the first UE 115-a, which may then provide the second UE 115-b with such information (e.g., in cases where the second UE 115-b is outside of coverage area 110-a or does not have an established access link connection with the network entity 105-a). In some cases, the first UE 115-a may transmit one or more uplink transmissions 215 to the network entity 105-a (e.g., energy harvesting capability or request information, sidelink resource pool request information, acknowledgments of successful receipt of configuration information, or other information). The first UE 115-a may transmit one or more sidelink transmissions 220 based on the ET/EH configuration to at least the second UE 115-b. Likewise, the second UE 115-b may transmit one or more sidelink transmissions 225 based on the ET/EH configuration to at least the first UE 115-a.

In some cases, one or both the first UE 115-a and the second UE 115-b may be energy harvester devices that have low power capability (e.g., they may be IoT devices that obtain operating power at least partially through energy harvesting). While various examples describe devices that operate in ET/EH power modes, techniques as discussed herein may be applied in other cases as well, in which it may be desirable to operate a device in a low power mode (e.g., if a UE 115 is in a low battery state and substantial power reductions are implemented to conserve at least a small amount of communications capability).

In some cases, the ET/EH configuration 210 may indicate that one or more resource pools, or a portion of one or more resource pools, from resource pool configuration 205, is configured for ET/EH and may provide ET/EH parameters. Such ET/EH parameters may include, for example, an ET/EH waveform (e.g., a SRS waveform, a CSI-RS waveform, or a new waveform or reference signal, that can be used for energy harvesting at a receiving device), a charging rate, a portion of the resource pool used for ET/EH, or any combinations thereof. In some cases, the ET/EH resources may include one or more BWPs in a resource pool that are outside of other BWPs for data transfer, and may have their own SCS, frequency location, bandwidth, or any combinations thereof.

In some cases, the sidelink ET/EH configuration 210 may be provided in sidelink control information (SCI), such as SCI that reserves resources (e.g., SCI-1), or SCI that indicates a configuration of multiple available configurations (e.g., SCI-2). In cases where a resource pool is exclusively for ET/EH, the associated configuration information may be provided in a different resource pool (e.g., in SCI of a different sidelink resource pool), and the ET/EH resource pool may have all gaps and symbols used for AGC removed. In some cases, SCI may indicate reserved/scheduled ET/EH resources using one or more new fields, in an associated ET/EH SCI format, or any combinations thereof. Such techniques may provide for efficient indication of ET/EH resources and associated parameters, which allow for one or more devices to obtain at least a portion of their power to enable communications or prolong operating/battery life of the one or more devices.

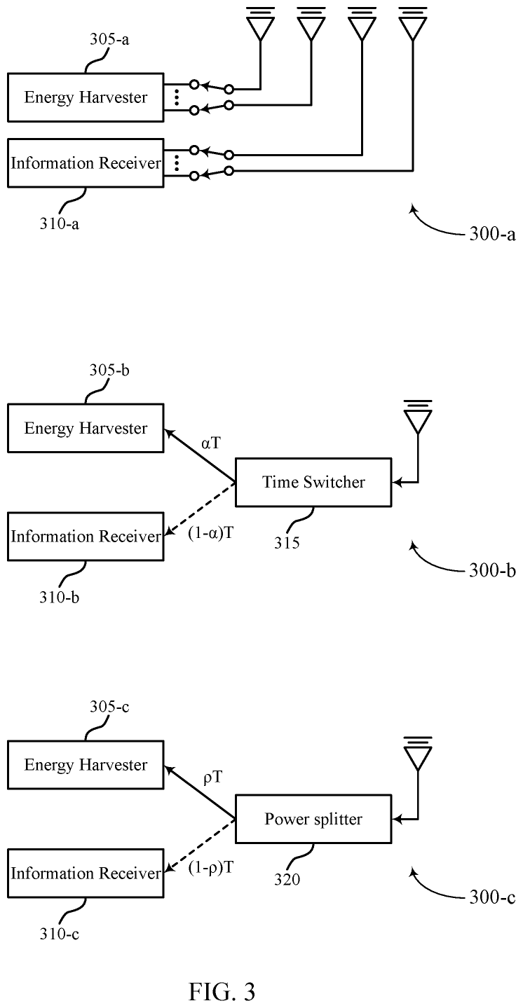

In various aspects, sidelink resource selection for ET/EH resources may be made by different devices. For example, if the second UE 115-b needs energy from the first UE 115-a, the resources that are used to send the energy may be determined by the first UE 115-a, may be determined by the second UE 115-b, or may be assigned by the network entity 105-a (e.g., in a Mode 1 resource allocation). Various aspects of resource pool and ET/EH parameter selection and indication are discussed herein with reference to FIGS. 3 through 7.

FIG. 3 illustrates an example of energy harvesting schemes 300 in accordance with one or more aspects of the present disclosure. A first example scheme 300-a illustrates aspects of a separated receiver architecture for energy harvesting. The separated receiver architecture may include an energy harvester 305-a and an information receiver 310-a, and the energy harvester 305-a may be connected to different antennas from the information receiver 310-a. A second example scheme 300-b illustrates aspects of a time-switching architecture for energy harvesting. The time-switching architecture may include an energy harvester 305-b, an information receiver 310-b, and a time switcher 315. A third example scheme 300-c illustrates aspects of a power-splitting architecture for energy harvesting. The power-splitting architecture may include an energy harvester 305-c, an information receiver 310-c, and a power splitter 320.

The time-switching architecture may allow a node (e.g., such as a UE 115) to switch between the energy harvester 305-b and the information receiver 310-b. In some cases, energy harvested at a receiver j from a source i may be calculated using the below, where 0≤α≤1 may be a fraction of time allocated for energy harvesting.

$${E}_{j} = η {P}_{i} {\vert {g}_{i - j} \vert}^{2} α T$$

In some examples, a data rate for communications using the time-switching architecture may be given by the below equation, where κ may denote a noise spectral density and W may denote a channel bandwidth.

$${R}_{i - j} = ( 1 - α ) {log}_{2} ( 1 + \frac{{\vert {g}_{i - j} \vert}^{2} {P}_{i}}{κ W} )$$

In the power-splitting architecture, received RF signals may be split into two streams for the energy harvester 305-c and the information receiver 310-c with different power levels. In some cases, energy harvested at a receiver j from a source i may be calculated using the below equation, where 0≤ρ≤1 may be a fraction of power allocated for energy harvesting.

$${E}_{j} = η ρ {P}_{i} {\vert {g}_{i - j} \vert}^{2} T$$

In some examples, a data rate for communications using the power-switching architecture may be given by the below equation, where κ may denote a noise spectral density and W may denote a channel bandwidth.

$${R}_{i - j} = {log}_{2} ( 1 + \frac{{\vert {g}_{i - j} \vert}^{2} ( 1 - ρ ) {P}_{i}}{κ W} )$$

In some cases, as discussed with reference to FIG. 2, a sidelink communications device, or a network entity, may determine energy harvesting parameters for one or more energy harvesting resources of one or more sidelink communications resource pools.

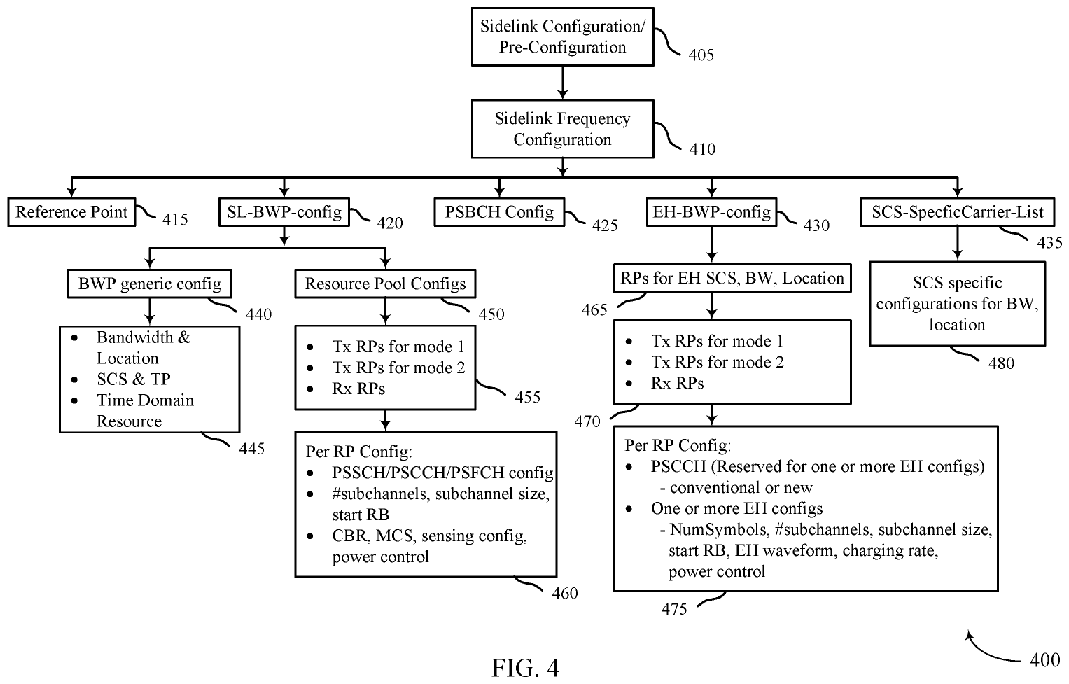

FIG. 4 illustrates an example of a sidelink resource pool configuration 400 that supports energy transfer for sidelink communications in accordance with one or more aspects of the present disclosure. The sidelink resource pool configuration 400 may be implemented in a system that uses sidelink communications, such as in a wireless communications system 100 or 200 as described with reference to FIG. 1 or 2.

In the example, of FIG. 4, one or more sidelink configurations 405 (or pre-configurations) may be provided to one or more sidelink UEs (e.g., provided by a network entity). Each sidelink configuration 405 may indicate various associated parameters, including a sidelink frequency configuration 410 (which in some cases may be similar to the configuration of a carrier for an access link such as a Uu link). The sidelink frequency configuration 410 may provide, for example, reference point information 415 (e.g., a frequency reference point associated with a set of configured frequency resources), sidelink BWP configuration information 420, physical sidelink broadcast channel (PBSCH) information 425, energy harvesting BWP configuration 430 information, and SCS specific carrier list 435 information.

In some cases, the sidelink BWP configuration information 420 may include a BWP generic configuration 440 that indicates parameters 445 such as bandwidth and location of the resource pool, SPS and transmit power for the resource pool, and time domain resources for the resource pool. The sidelink BWP configuration information 420 may also include one or multiple resource pool configurations 450 that provide resource pool identifications 455 (e.g., transmit resource pools for mode 1 or mode 2 sidelink communications, and receive resource pools), and per resource pool information 460 (e.g., information for one or more physical sidelink shared channel (PSSCH), physical sidelink control channel (PSCCH), or physical sidelink feedback channel (PSFCH) configurations, a number of subchannels, subchannel size, subchannel starting resource block (RB), a channel busy ratio (CBR), a modulation and coding scheme (MSC), sensing configuration, power control configuration, or any combinations thereof).

In some cases, the energy harvesting BWP configuration 430 may include energy harvesting information for one or more resource pools 465, which may indicate, for energy harvesting signals, one or more of SCS, bandwidth, and location (e.g., frequency location, time location, or both). The energy harvesting information for one or more resource pools 465 may indicate, for example, resource pool identifications 470 (e.g., transmit resource pools for mode 1 or mode 2 sidelink communications, and receive resource pools configured for energy harvesting), and per resource pool information 475 for energy harvesting resources (e.g., information for one or more of PSCCH configuration (e.g., PSCCH reserved for energy harvesting configurations), a number of symbols, a number of subchannels, subchannel size, subchannel starting RB, energy harvesting waveform, charging rate, power control configuration, or any combinations thereof). The SCS specific carrier list 435 in this example may include information 480 that provides SCS specific configurations for bandwidth or location of the resource pools.

Thus, in the example of FIG. 4, the resource pools for energy harvesting are configured in the energy harvesting BWP configuration 430 separately from configurations of other BWPs for data provided in sidelink BWP configuration information 420. Such configuration provides that the sidelink energy harvesting BWPs may have their own SCS, location in frequency, and other parameters, as described above. In some cases, a time gap for RF retuning may be needed when a UE transitions between data and energy harvesting resources (e.g., between a sidelink (SL) BWP, a downlink/uplink (DL/UL) BWP, and an energy harvesting resource pool BWP), when the energy harvesting BWP is different than the SL-BWP. Such a gap may depend on the UE capabilities, on whether the SCS, BWP location, center frequency are the same, or any combinations thereof.

In some cases, as discussed above, energy harvesting may have multiple types of waveforms (e.g., having different methods and parameters of generation), and a particular waveform may be selected based on charging rates. Such waveforms may be related to aspect of how a reference signal is generated. For example, energy transfer signals for energy harvesting may be SRS signals, CSI-RS signals, pulse amplitude modulation (PAM), phase shift keying (PSK), pulse position modulation (PPM), QAM, ON-OFF keying (OOK), amplitude shift keying (ASK), Zadoff Chu sequences, discrete Fourier transform-based (DFT) sequences, Gaussian/circularly symmetric Gaussian/improper Gaussian signals, Bernoulli signals, or other types of modulations and distributions that are generated using a configured/preconfigured scrambling ID or seeds that are used an input to a pseudo-random generators or completely generated randomly without sharing IDs or seeds (e.g., only transmitter knows the sequence). Additionally, or alternatively, energy transfer signals may also be signals based on new waveforms or reference signals that are optimized from time to time to achieve an enhanced metric such as charging rate performance (e.g., new designed amplitudes and phases on each resource element to achieve enhanced performance) which may be determined at one device (e.g., network entity/central unit) and shared among a set of devices (e.g., energy transfer devices). In some cases, the energy harvesting waveform may be a CP-OFDM or SC (e.g., DFT-s-OFDM vs SC QAM) waveform, may be single-tone (e.g., sine wave) or multi-tone (e.g., multi-sine, in which charging rate and energy harvesting efficiency, especially at lower input power, can increase with an increasing the number of frequency tones. In some cases, for example, CP-OFDM may provide relatively efficient charging but as a cell edge may cause a relatively high peak-to-average-power-ratio (PAPR) to the data/energy transmitter, which may be a factor in the waveform selection. For example, for enhanced energy transfer, a system with high PAPR capability (e.g., having efficient high-power amplifiers) may be designed similar to any OFDM system design. In some cases, enhanced energy transfer sequence/modulation can be obtained based on some constraints on the PAPR of the system (e.g., depending on power amplifier efficiency). Additionally, digital generation versus analog generation of an energy signal, and time domain versus frequency domain generation may be factors for selection of the waveform. In some cases, waveforms with an increased number of energy bursts (e.g., multi-tone/OFDM) may allow for activation components such as diodes in energy harvesting circuitry, may increase sensitivity of rectifying circuits in some relatively low-power operations, and may also provide higher second and higher order (e.g., moment) statistics on the received energy transfer signal (e.g. E{y(t)⁴)} where E{.} is the expectation/average operator and y(t) is the received signal at the energy harvesting module/circuit).

Multi-tone waveforms, such as OFDM-based waveforms, have relatively favorable E{y(t)⁴)} values which increases with number of tones/subcarriers of the signal. In addition, any modulation schemes such as PAM/PSK/PPM/QAM/OOK/ASK/Zadoff Chu/DFT-based/Gaussian/circularly symmetric Gaussian/improper Gaussian/Bernoulli and other types of modulations and distributions that have relatively good E{y(t)⁴)} may be used. For example, an OOK scheme may be used with the following design. The zero-value constellation point is generated with probability

$$1 - \frac{1}{{ℓ}^{2}} ,$$

and the other constellation point, non-zero (1) constellation point, is generated with an amplitude of l\sqrt{P} and with probability 1/l². With controlling the parameter, the energy generator device can achieve different charging rates at the energy harvesting, device since E{y(t)⁴)} changes based on l.

As part of the configuration, the type of the signal carried on the waveform may be configured (e.g., PAM/PSK/PPM/QAM/OOK/ASK/Zadoff Chu/DFT-based/Gaussian/circularly symmetric Gaussian/improper Gaussian/Bernoulli and other types of modulations and distributions) based on factors such as the energy transfer device capability to support such modulation, charging rate, feedback from energy harvesting device on which waveform and modulation is best/desired/suggested, or any combinations thereof.

In some cases, information regarding reserving the energy harvesting resources for a first resource pool may be signaled in SCI of a second resource pool or a primary resource pool used for controlling a set of energy harvesting resource pools. Such a separation may allow more efficient energy transfer, because energy harvesting may be performed in the analog domain, and providing the digital domain SCI in a different resource pool may allow all of the signals of the energy harvesting resource pool to be used for energy transfer. Further, in some cases, when energy harvesting is performed on a resource pool without any SCI and without any data resources, (e.g., the energy harvesting resource pool contains only energy transfer signals), all gaps and symbols used for AGC may be removed from the associated resource pool. In some cases, an SCI (e.g., SCI-1) may be transmitted before sending the energy transfer signal, that may indicate the reserved or scheduled resources for energy harvesting. In some cases, a slot carrying the SCI may not carry any PSSCH transmissions.

In other cases, one or more fields in SCI or a separate energy harvesting SCI format may be provided. For example, such an SCI may be scrambled with a different radio network temporary identifier (RNTI), such as an EH_RNTI, which may be transmitted a predetermined number of symbols or slots (e.g., X symbols or slots) before energy harvesting transmissions starts. In some cases, frequency domain resources may be semi-statically configured per resource pool for energy harvesting, and the EH_RNTI transmission may indicate activation. In some cases, the number of symbols or slots may be a function of UE capability for switching between receiving SCI and activating an analog-domain energy harvesting circuit.

In some cases, a network entity may configure multiple energy harvesting resources per resource pool, and a transmitting UE (or other transmitting sidelink device) may select one and provide an indication of the selected resource via SCI. In other cases, radio resource control (RRC) signaling (e.g., PC5 RRC) or a MAC control element (MAC-CE) may be used to indicate the selection of a resource among the available resources for energy harvesting per resource pool.

In some cases, a transmitting UE may transmit energy transfer signals in energy harvesting resources that may be used by multiple receiving UEs (or other devices) for energy harvesting. In such cases, unlike unicast data, energy harvesting may be capable of one-to-everyone or one-to-many configurations where all UEs in need of energy may harvest from the current transmissions. In some cases, the transmitting UE may adjust power control and analog or digital beamforming based on the intended receiving UE or group of UEs.

In some further cases, if the energy harvesting resource pool is configured to carry data, one or more other parameters may be configured for the resource pool, such as a time for switching between data signals and energy transfer signals (e.g., a number of consecutive symbols for data from total number of symbols for PSSCH; and a gap between data and energy harvesting). In some cases, a switching time may be a function of UE capability of such switching. Such parameters may also include, for example, power splitting (PS) factors for use at one or more receiving UEs, which may be configured per resource pool. Such PS factors may be set, in some cases, based on a receiving UE capability to refine and adjust PS factors (e.g., a UE can have a set of options based on hardware capability for PS factors).

In some further cases, a dedicated resource pool for energy harvesting may be configured, which may only schedule sidelink energy harvesting signals. In such cases, only PSCCH/SCI-2 may be needed to be configured, which may be configured using a same format as used for data communications, or may be a separate SCI format or have one or more or fields for energy harvesting parameters. In cases where a same SCI format is used for data and energy harvesting, the SCI-1 may be common between both data and energy harvesting, such that all UEs can decode it, and SCI-2 may include energy harvesting information. In some cases, the SCI that provides information for data transmissions may not include information related to energy harvesting, and another control signal is provided with the information of energy harvesting configuration (e.g., in SCI-2). In other cases, some information in a common SCI for data and energy harvesting (e.g., SCI-1) may be replaced with energy harvesting configuration information. For example, MCS or number of ports information may be replaced with energy harvesting information (e.g., that indicates to use a certain energy harvesting configuration, or that indicates parameters related to power splitting or time switching). If the SCI is specific to energy harvesting, then one or more fields may be used to indicate selected sidelink energy harvesting configurations.

In some cases, when a dedicated resource pool (or dedicated ET/EH BWP) is used with PSCCH providing a SCI that is specific to energy harvesting, an associated PSFCH may be enabled to report a charging rate or an indication of bad or good charging from energy harvesting device to energy transfer device (e.g., based on a configured charging rate per resource pool). In other cases, the PSFCH configuration may be removed or PSFCH can be disabled. In other cases, one or more other resource pools (e.g., a resource pool or BWP that is configured with PSSCH resources) may be used to indicate whether charging is good or bad. In such cases, UEs (or a network entity that configures sidelink resources) may exchange signaling (e.g., using L1/L2/L3 signaling such as SCI/PC5-MAC-CE/PC5-RRC) that indicates a resource pool that is used for feedback about charging when a dedicated energy transfer resource pool is used for charging (and it has no PSFCH enabled or if such pool(s) do not have PSFCH at all). For example, a first resource pool may be dedicated for energy transfer and may not have PSFCH resources or PSFCH resources may not be enabled, and charging rate feedback reporting may be provided via a PSFCH on a second resource pool (e.g., that includes data resources).

In some further cases, if a resource pool is used for both data and energy harvesting, a portion of the resource pool configure for energy harvesting may have its own parameters related to sensing configuration (e.g., configured reference signal received power (RSRP)), CBR configuration, power control (e.g., used to control the charging rate), or any combinations thereof. In some further cases, a sidelink resource pool for energy harvesting may be scheduled using mode 1 sidelink resource allocation (e.g., a network entity schedules sidelink resource allocations), or may be scheduled using mode 2 sidelink resource allocation (e.g., a UE schedules sidelink resource allocations).

In some further cases, energy harvesting signals and data transmission signals may be transmitted using overlapping time and frequency resources of a configured sidelink resource pool. In such cases, the energy signals may be generated in a deterministic manner that is known to all sidelink devices (e.g., based on configuration information provided in the resource pool configuration). A receiving device may receive the overlapping signals may use interference mitigation techniques to cancel the energy harvesting signals from the received signals (e.g., by regenerating the energy harvesting signal based on the deterministic generation manner and configuration information), to provide resultant data signals. The receiving device may then decode the resultant data signals.

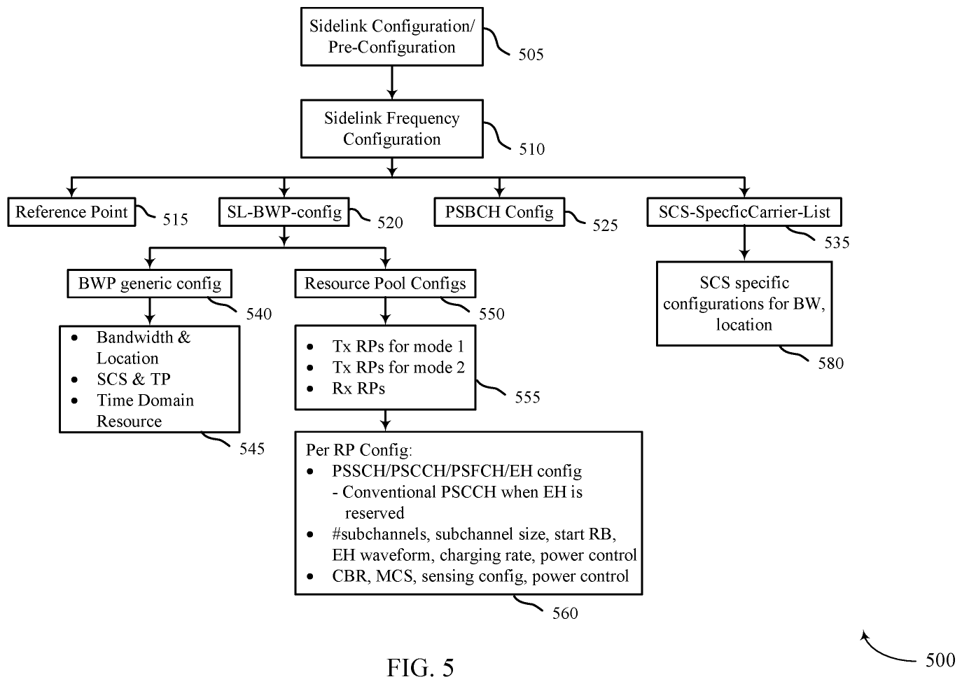

In the example of FIG. 4, as discussed, separate resource pool configuration information is provided for energy harvesting configurations within one or more sidelink resource pools. In other cases, such as illustrated in FIG. 5, energy harvesting configurations may be provided along with other sidelink resource pool information.

FIG. 5 illustrates an example of a sidelink resource pool configuration 500 that supports energy transfer configuration for sidelink communications in accordance with one or more aspects of the present disclosure. The sidelink resource pool configuration 500 may be implemented in a system that uses sidelink communications, such as in a wireless communications system 100 or 200 as described with reference to FIG. 1 or 2.

In the example, of FIG. 5, one or more sidelink configurations 505 (or pre-configurations) may be provided to one or more sidelink UEs (e.g., provided by a network entity). Each sidelink configuration 505 may indicate various associated parameters, including a sidelink frequency configuration 510 (which in some cases may be similar to the configuration of a carrier for an access link such as a Uu link). The sidelink frequency configuration 510 may provide, for example, reference point information 515 (e.g., a frequency reference point associated with a set of configured frequency resources), sidelink BWP configuration information 520, physical sidelink broadcast channel (PBSCH) information 525, and SCS specific carrier list 535 information.

In this aspect, the sidelink BWP configuration information 520 may include a BWP generic configuration 540 that indicates parameters 545 such as bandwidth and location of the resource pool, SPS and transmit power for the resource pool, and time domain resources for the resource pool. The sidelink BWP configuration information 520 may also include one or multiple resource pool configurations 550 that provide resource pool identifications 555 (e.g., transmit resource pools for mode 1 or mode 2 sidelink communications, and receive resource pools), and per resource pool information 560 that includes energy harvesting information (e.g., PSSCH, PSCCH, PSFCH, and energy harvesting configurations, a number of subchannels, subchannel size, subchannel starting RB, a CBR, a MCS, sensing configuration, power control configuration, energy harvesting waveform, a charging rate, or any combinations thereof). The SCS specific carrier list 535 in this example may include information 580 that provides SCS specific configurations for bandwidth or location of the resource pools.

Thus, in the example of FIG. 5, the resource pools for energy harvesting are configured in the energy harvesting BWP configuration that is provided together with configurations of other BWPs for data in sidelink BWP configuration information 520. Thus, in such cases, the energy harvesting reservation may be provided with first SCI (e.g., SCI-1) that provides information for sidelink data transmissions, and second SCI (e.g., SCI-2 carried on PSSCH) may include one or more fields that indicate one or more selected energy harvesting parameters (e.g., that are select from one or more energy harvesting configurations).

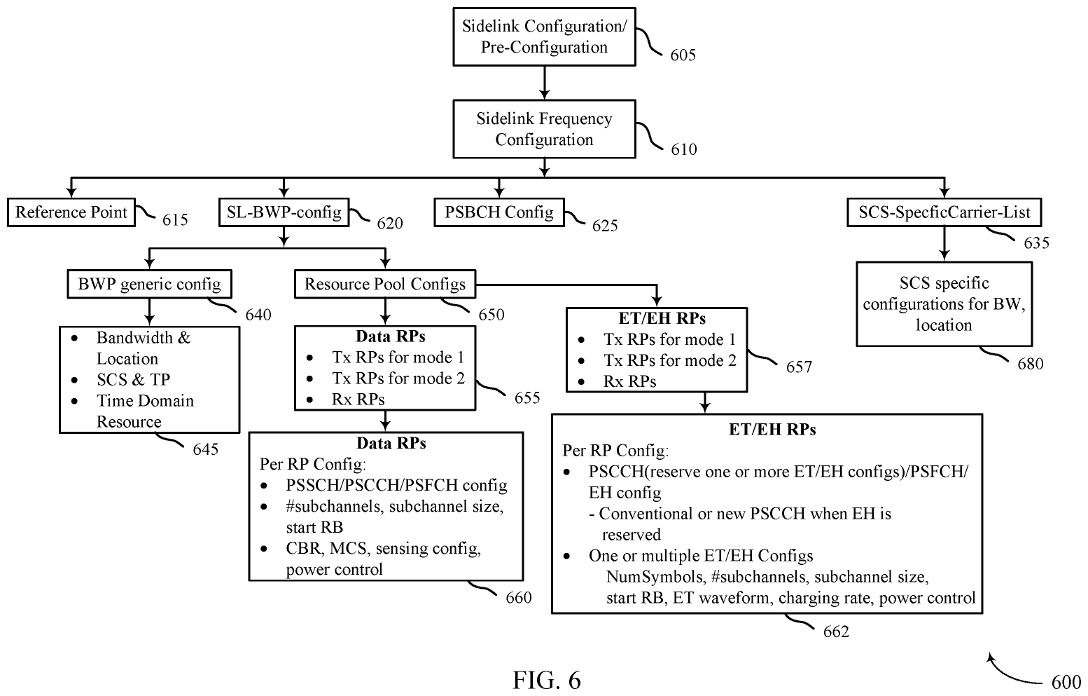

FIG. 6 illustrates an example of a sidelink resource pool configuration 600 that supports energy transfer configuration for sidelink communications in accordance with one or more aspects of the present disclosure. The sidelink resource pool configuration 600 may be implemented in a system that uses sidelink communications, such as in a wireless communications system 100 or 200 as described with reference to FIG. 1 or 2.

In the example, of FIG. 6, one or more sidelink configurations 605 (or pre-configurations) may be provided to one or more sidelink UEs (e.g., provided by a network entity). Each sidelink configuration 605 may indicate various associated parameters, including a sidelink frequency configuration 610 (which in some cases may be similar to the configuration of a carrier for an access link such as a Uu link). The sidelink frequency configuration 610 may provide, for example, reference point information 615 (e.g., a frequency reference point associated with a set of configured frequency resources), sidelink BWP configuration information 620, physical sidelink broadcast channel (PBSCH) information 625, and SCS specific carrier list 635 information.

In this aspect, the sidelink BWP configuration information 620 may include a BWP generic configuration 640 that indicates parameters 645 such as bandwidth and location of the resource pool, SPS and transmit power for the resource pool, and time domain resources for the resource pool. The sidelink BWP configuration information 620 may also include one or multiple resource pool configurations 650 for data resource pools 655 and dedicated ET/EH resource pools 657. In cases where separate resource pools are provided, data resource pools 655 may have resource pool identifications (e.g., transmit resource pools for mode 1 or mode 2 sidelink communications, and receive resource pools), and per resource pool information 660 that includes resource pool information (e.g., PSSCH, PSCCH, PSFCH configurations, a number of subchannels, subchannel size, subchannel starting RB, a CBR, a MCS, sensing configuration, power control configuration, or any combinations thereof). For dedicated ET/EH resource pools 657, per resource pool information 662 may include energy harvesting information (e.g., PSCCH, PSFCH, and energy harvesting configurations, a number of symbols, number of subchannels, subchannel size, subchannel starting RB, energy harvesting waveform, a charging rate, power control, or any combinations thereof). The SCS specific carrier list 635 in this example may include information 680 that provides SCS specific configurations for bandwidth or location of the resource pools.

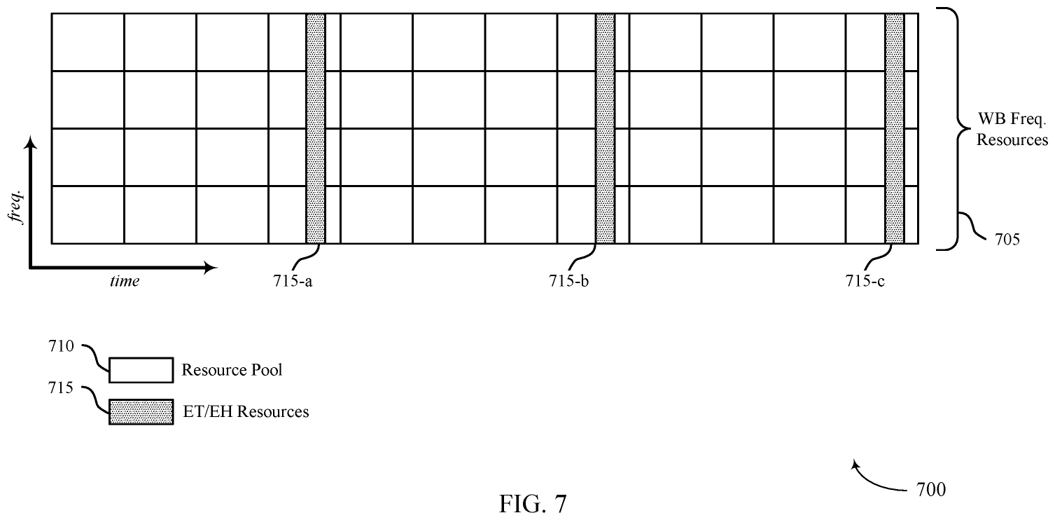

FIG. 7 illustrates an example of wideband sidelink resources 700 that support energy transfer configuration for sidelink communications in accordance with one or more aspects of the present disclosure. The wideband sidelink resources 700 may be implemented in a system that uses sidelink communications, such as in a wireless communications system 100 or 200 as described with reference to FIG. 1 or 2.

In this example, sidelink resource pools 710 may be configured that span a wideband set of frequency resources 705 (e.g., that span four BWPs). In this example, ET/EH resources 715 may span multiple BWPs of the wideband set of frequency resources 705. In the example of FIG. 7, the energy harvesting resources 715 may be configured as periodic resources (e.g., in every fourth slot) such that a first set of ET/EH resources 715-a, a second set of ET/EH resources 715-b, and a third set of ET/EH resources 715-c, provided, which may be used by a receiving device for energy accumulation. In such cases, one or more selected UEs (e.g., operating in a mode 1 manner) may be indicated to send energy signals to another group of UEs, and in some cases the wideband energy harvesting resources 715 are not used for transmission of other data or control signals.

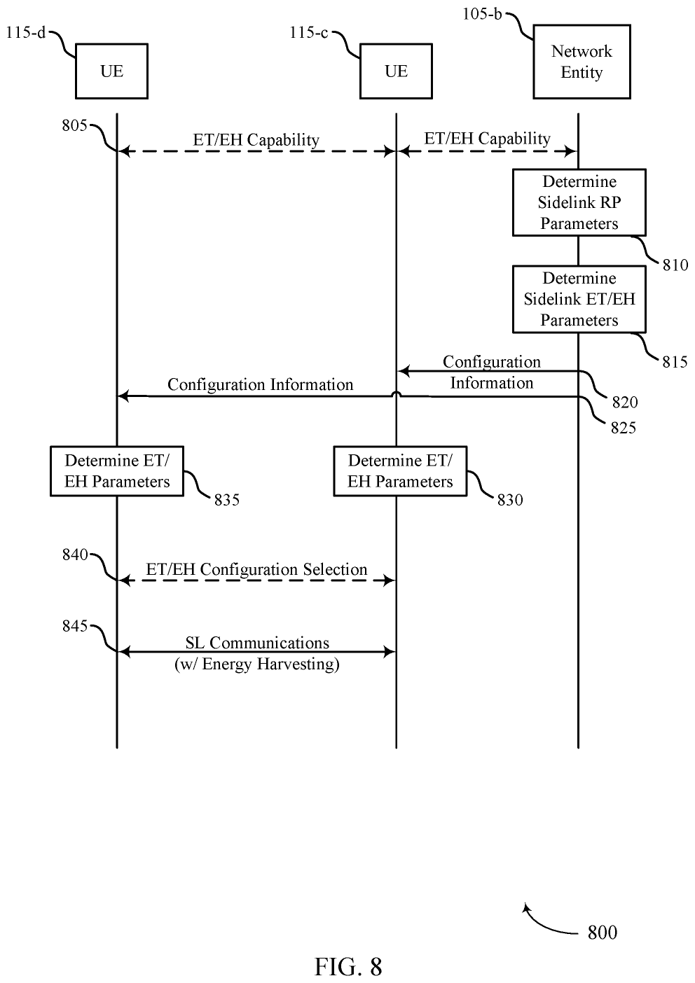

FIG. 8 illustrates an example of a process flow 800 that supports energy transfer configuration for sidelink communications in accordance with one or more aspects of the present disclosure. Process flow 800 includes first UE 115-c and second UE 115-d, which may be examples of UEs 115 described with reference to FIGS. 1-2. Process flow 800 also includes a network entity 105-b, which may be an example of a network entity 105 described with reference to FIGS. 1-2. The process flow 800 may implement aspects of wireless communications system 100 or 200. For example, the process flow 800 may support efficient techniques for power control configuration and signaling for communications with energy harvesting.

In the following description of the process flow 800, the signaling exchanged between the UEs 115, and between the UEs 115 and the network entity 105, may be exchanged in a different order than the example order shown, or the operations performed by the UEs 115 and the network entity 105 may be performed in different orders or at different times. Some operations may also be omitted from the process flow 800, and other operations may be added to the process flow 800.

Optionally, at 805, the first UE 115-c and the second UE 115-d may exchange ET/EH capabilities, which may also be exchanged with the network entity 105-b. Such ET/EH capabilities may include information related to, for example, an ability of the UE 115 to perform ET/EH, capability for canceling energy transfer signals from data signals, capability for switching times between ET/EH and data transmissions, capabilities for wideband ET/EH, or any combinations thereof. In some cases, a request or recommendation for one or more ET/EH configurations or parameters may be provided to the network entity 105-b. In some cases, such ET/EH capability or request information may be provided in RRC signaling, in a MAC-CE, in uplink control information, in SCI, or any combinations thereof.

At 810, the network entity 105-b may determine parameters for one or more sidelink communications resource pools. Such sidelink resource pool parameters may include parameters such as discussed with reference to FIGS. 4 and 5. At 815, the network entity 105-b may determine parameters for sidelink ET/EH in one or more of the sidelink communications resource pools. In some cases, as discussed herein, one or more sidelink resource pools may be used for both ET/EH and data communications. Additionally, or alternatively, one or more sidelink resource pools may be configured exclusively for ET/EH.

At 820, the network entity 105-b may transmit configuration information to the first UE 115-c that indicates the one or more sidelink resource pool configurations and the ET/EH parameters for one or more sidelink resource pools. In some case, the configuration information may be transmitted in broadcast information to multiple UEs 115. In other cases, the configuration information may be transmitted separately to each UE 115, and at 825 the network entity 105-b may transmit the configuration information to the second UE 115-d.

At 830, the first UE 115-c may determine ET/EH parameters for the one or more sidelink resource pools. Likewise, at 835, the second UE 115-d may determine ET/EH parameters for the one or more sidelink resource pools. The ET/EH parameters may be determined in accordance with techniques as discussed herein, such as techniques described with reference to FIGS. 2 through 7. Optionally, at 840, the first UE 115-c and the second UE 115-d may exchange information related to a selected ET/EH configuration (e.g., a particular ET/EH configuration that is selected from multiple available configurations that are provided by the network entity 105-b). At 845, the first UE 115-c and the second UE 115-d may exchange sidelink communications with ET/EH. In some cases, the first UE 115-c may be a transmitting device and may transmit one or more energy transfer signals in accordance with the ET/EH configuration, and the second UE 115-d may accumulate power from the energy transfer signals, which may be used to provide some or all power for one or more operations at the second UE 115-d.

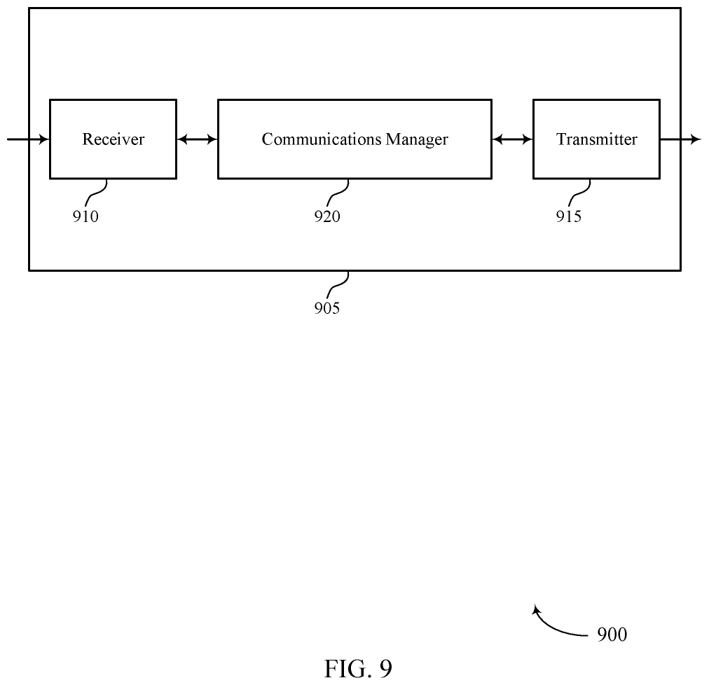

FIG. 9 shows a block diagram 900 of a device 905 that supports energy transfer configuration for sidelink communications in accordance with one or more aspects of the present disclosure. The device 905 may be an example of aspects of a UE 115 as described herein. The device 905 may include a receiver 910, a transmitter 915, and a communications manager 920. The device 905 may also include a processor. Each of these components may be in communication with one another (e.g., via one or more buses).

The receiver 910 may provide a means for receiving information such as packets, user data, control information, or any combination thereof associated with various information channels (e.g., control channels, data channels, information channels related to energy transfer configuration for sidelink communications). Information may be passed on to other components of the device 905. The receiver 910 may utilize a single antenna or a set of multiple antennas.

The transmitter 915 may provide a means for transmitting signals generated by other components of the device 905. For example, the transmitter 915 may transmit information such as packets, user data, control information, or any combination thereof associated with various information channels (e.g., control channels, data channels, information channels related to energy transfer configuration for sidelink communications). In some examples, the transmitter 915 may be co-located with a receiver 910 in a transceiver module. The transmitter 915 may utilize a single antenna or a set of multiple antennas.

The communications manager 920, the receiver 910, the transmitter 915, or various combinations thereof or various components thereof may be examples of means for performing various aspects of energy transfer configuration for sidelink communications as described herein. For example, the communications manager 920, the receiver 910, the transmitter 915, or various combinations or components thereof may support a method for performing one or more of the functions described herein.

In some examples, the communications manager 920, the receiver 910, the transmitter 915, or various combinations or components thereof may be implemented in hardware (e.g., in communications management circuitry). The hardware may include a processor, a digital signal processor (DSP), a central processing unit (CPU), a graphics processing unit (GPU), an application-specific integrated circuit (ASIC), a field-programmable gate array (FPGA) or other programmable logic device, a microcontroller, discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally, or alternatively, in some examples, the communications manager 920, the receiver 910, the transmitter 915, or various combinations or components thereof may be implemented in code (e.g., as communications management software) executed by a processor. If implemented in code executed by a processor, the functions of the communications manager 920, the receiver 910, the transmitter 915, or various combinations or components thereof may be performed by a general-purpose processor, a DSP, a CPU, a GPU, an ASIC, an FPGA, a microcontroller, or any combination of these or other programmable logic devices (e.g., configured as or otherwise supporting a means for performing the functions described in the present disclosure).

In some examples, the communications manager 920 may be configured to perform various operations (e.g., receiving, obtaining, monitoring, outputting, transmitting) using or otherwise in cooperation with the receiver 910, the transmitter 915, or both. For example, the communications manager 920 may receive information from the receiver 910, send information to the transmitter 915, or be integrated in combination with the receiver 910, the transmitter 915, or both to obtain information, output information, or perform various other operations as described herein.

The communications manager 920 may support wireless communication at a first UE in accordance with examples as disclosed herein. For example, the communications manager 920 may be configured as or otherwise support a means for receiving control signaling for a sidelink communications resource pool, the control signaling including an energy harvesting configuration for at least a portion of the sidelink communications resource pool, the energy harvesting configuration indicting one or more of a waveform for energy harvesting transmissions or an energy transfer level of the energy harvesting transmissions. The communications manager 920 may be configured as or otherwise support a means for determining, based on the energy harvesting configuration, one or more energy harvesting parameters for communications with a second UE via the sidelink communications resource pool. The communications manager 920 may be configured as or otherwise support a means for communicating with the second UE based on the one or more energy harvesting parameters.

By including or configuring the communications manager 920 in accordance with examples as described herein, the device 905 (e.g., a processor controlling or otherwise coupled with the receiver 910, the transmitter 915, the communications manager 920, or a combination thereof) may support techniques for efficient indication of energy harvesting resources and associated parameters, which allow for one or more devices to obtain at least a portion of their power to enable communications or prolong operating/battery life of the one or more devices.

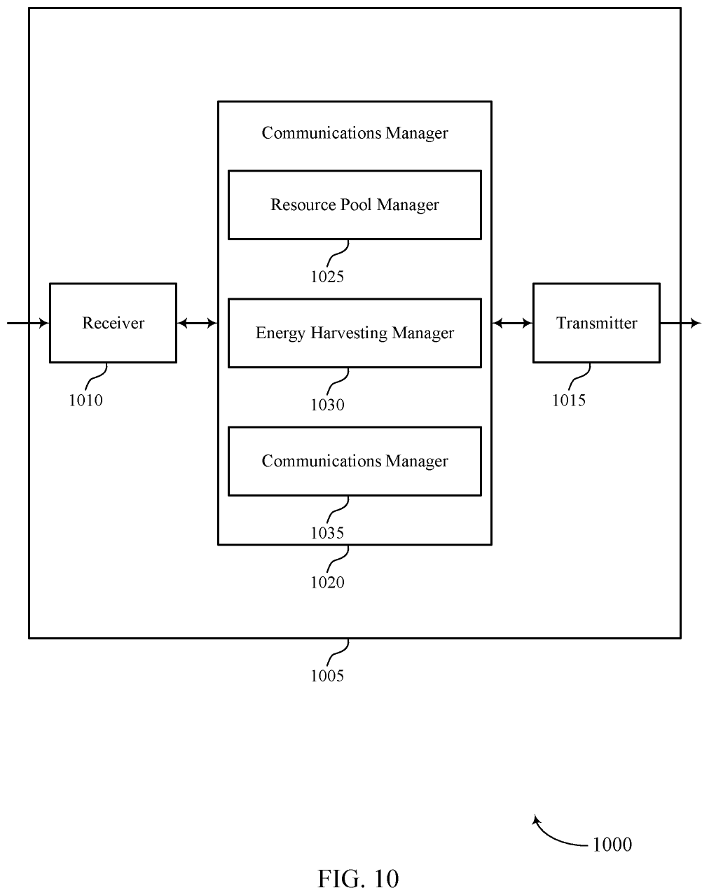

FIG. 10 shows a block diagram 1000 of a device 1005 that supports energy transfer configuration for sidelink communications in accordance with one or more aspects of the present disclosure. The device 1005 may be an example of aspects of a device 905 or a UE 115 as described herein. The device 1005 may include a receiver 1010, a transmitter 1015, and a communications manager 1020. The device 1005 may also include a processor. Each of these components may be in communication with one another (e.g., via one or more buses).

The receiver 1010 may provide a means for receiving information such as packets, user data, control information, or any combination thereof associated with various information channels (e.g., control channels, data channels, information channels related to energy transfer configuration for sidelink communications). Information may be passed on to other components of the device 1005. The receiver 1010 may utilize a single antenna or a set of multiple antennas.

The transmitter 1015 may provide a means for transmitting signals generated by other components of the device 1005. For example, the transmitter 1015 may transmit information such as packets, user data, control information, or any combination thereof associated with various information channels (e.g., control channels, data channels, information channels related to energy transfer configuration for sidelink communications). In some examples, the transmitter 1015 may be co-located with a receiver 1010 in a transceiver module. The transmitter 1015 may utilize a single antenna or a set of multiple antennas.

The device 1005, or various components thereof, may be an example of means for performing various aspects of energy transfer configuration for sidelink communications as described herein. For example, the communications manager 1020 may include a resource pool manager 1025, an energy harvesting manager 1030, a communications manager 1035, or any combination thereof. The communications manager 1020 may be an example of aspects of a communications manager 920 as described herein. In some examples, the communications manager 1020, or various components thereof, may be configured to perform various operations (e.g., receiving, obtaining, monitoring, outputting, transmitting) using or otherwise in cooperation with the receiver 1010, the transmitter 1015, or both. For example, the communications manager 1020 may receive information from the receiver 1010, send information to the transmitter 1015, or be integrated in combination with the receiver 1010, the transmitter 1015, or both to obtain information, output information, or perform various other operations as described herein.

The communications manager 1020 may support wireless communication at a first UE in accordance with examples as disclosed herein. The resource pool manager 1025 may be configured as or otherwise support a means for receiving control signaling for a sidelink communications resource pool, the control signaling including an energy harvesting configuration for at least a portion of the sidelink communications resource pool, the energy harvesting configuration indicting one or more of a waveform for energy harvesting transmissions or an energy transfer level of the energy harvesting transmissions. The energy harvesting manager 1030 may be configured as or otherwise support a means for determining, based on the energy harvesting configuration, one or more energy harvesting parameters for communications with a second UE via the sidelink communications resource pool. The communications manager 1035 may be configured as or otherwise support a means for communicating with the second UE based on the one or more energy harvesting parameters.

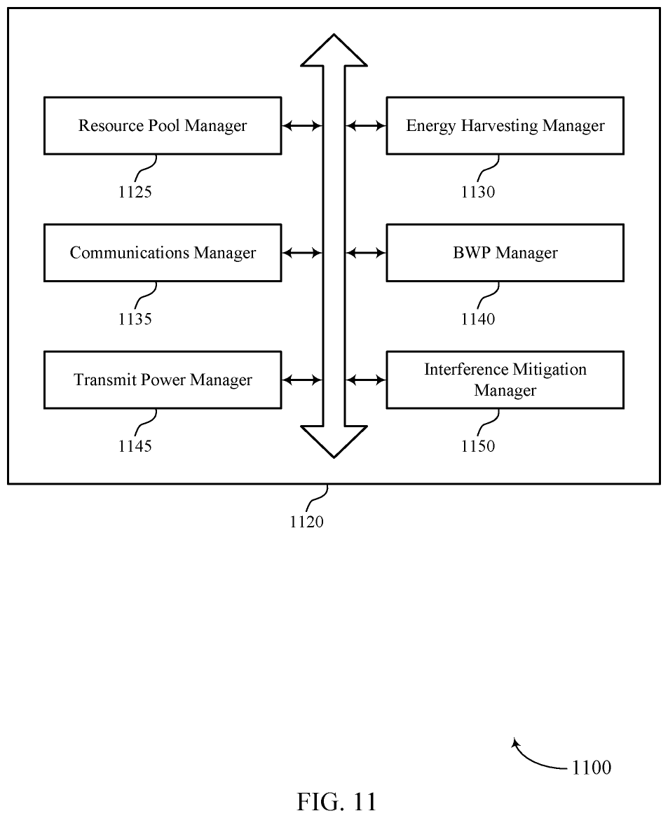

FIG. 11 shows a block diagram 1100 of a communications manager 1120 that supports energy transfer configuration for sidelink communications in accordance with one or more aspects of the present disclosure. The communications manager 1120 may be an example of aspects of a communications manager 920, a communications manager 1020, or both, as described herein. The communications manager 1120, or various components thereof, may be an example of means for performing various aspects of energy transfer configuration for sidelink communications as described herein. For example, the communications manager 1120 may include a resource pool manager 1125, an energy harvesting manager 1130, a communications manager 1135, a BWP manager 1140, a transmit power manager 1145, an interference mitigation manager 1150, or any combination thereof. Each of these components may communicate, directly or indirectly, with one another (e.g., via one or more buses).

The communications manager 1120 may support wireless communication at a first UE in accordance with examples as disclosed herein. The resource pool manager 1125 may be configured as or otherwise support a means for receiving control signaling for a sidelink communications resource pool, the control signaling including an energy harvesting configuration for at least a portion of the sidelink communications resource pool, the energy harvesting configuration indicting one or more of a waveform for energy harvesting transmissions or an energy transfer level of the energy harvesting transmissions. The energy harvesting manager 1130 may be configured as or otherwise support a means for determining, based on the energy harvesting configuration, one or more energy harvesting parameters for communications with a second UE via the sidelink communications resource pool. The communications manager 1135 may be configured as or otherwise support a means for communicating with the second UE based on the one or more energy harvesting parameters.

In some examples, to support receiving the control signaling, the energy harvesting manager 1130 may be configured as or otherwise support a means for receiving an indication that a first waveform of two or more different energy harvesting waveforms is selected for energy harvesting, where the first waveform is selected based on a target amount of energy to be transferred in the energy harvesting transmissions.

In some examples, to support receiving the control signaling, the resource pool manager 1125 may be configured as or otherwise support a means for receiving a first sidelink communications resource pool configuration for a first resource pool in which all available resources are allocated for the energy harvesting transmissions, or in which a portion of the available resources are allocated for the energy harvesting transmissions. In some examples, the control signaling for two or more sidelink communications resource pools is provided by a network entity that configures sidelink communications between the first UE and the second UE, and where at least one of the two or more sidelink communications resource pools includes the energy harvesting configuration. In some examples, the energy harvesting configuration indicates one or more of a charging rate associated with the energy harvesting transmissions, a waveform type of the energy harvesting transmissions, a portion of the sidelink communications resource pool that is allocated for the energy harvesting transmissions, or any combinations thereof. In some examples, the sidelink communications resource pool includes at least a first bandwidth part for the energy harvesting transmissions and a second bandwidth part for data communications, and where the first bandwidth part and second bandwidth part have separately configured subcarrier spacing, frequency locations, or any combinations thereof.

In some examples, to support receiving the control signaling, the energy harvesting manager 1130 may be configured as or otherwise support a means for receiving two or more energy harvesting configurations for the sidelink communications resource pool in a first sidelink control information communication. In some examples, to support receiving the control signaling, the energy harvesting manager 1130 may be configured as or otherwise support a means for receiving an indication of a selected energy harvesting configuration of the two or more energy harvesting configurations in a second sidelink control information communication, and where communications with the second UE are performed in accordance with the selected energy harvesting configuration. In some examples, the sidelink communications resource pool is a first sidelink communications resource pool having the energy harvesting configuration, and the control signaling is received in a second sidelink communications resource pool that is different than the first sidelink communications resource pool. In some examples, the first sidelink communications resource pool provides resources for the energy harvesting transmissions only, without resources for automatic gain control. In some examples, the control signaling is received prior to the energy harvesting transmissions, and indicates resources of the sidelink communications resource pool that are reserved for the energy harvesting transmissions.

In some examples, to support receiving, the energy harvesting manager 1130 may be configured as or otherwise support a means for receiving energy-harvesting-specific sidelink control information that indicates the waveform for the energy harvesting transmissions and the energy transfer level for the energy harvesting transmissions. In some examples, the energy harvesting manager 1130 may be configured as or otherwise support a means for selecting a first energy harvesting configuration from a set of multiple energy harvesting configurations provided by the control signaling. In some examples, the energy harvesting manager 1130 may be configured as or otherwise support a means for transmitting an indication to the second UE of the selected first energy harvesting configuration.

In some examples, the transmit power manager 1145 may be configured as or otherwise support a means for adjusting a transmit power for the energy harvesting transmissions based on a number of receiving UEs that are to receive the energy harvesting transmissions. In some examples, the communications manager 1135 may be configured as or otherwise support a means for transmitting the energy harvesting transmissions in the sidelink communications resource pool.

In some examples, the sidelink communications resource pool is configured for both data transmissions and the energy harvesting transmissions, and where the energy harvesting configuration indicates one or more time switching parameters or power splitting parameters for the data transmissions and the energy harvesting transmissions. In some examples, the sidelink communications resource pool is configured for only the energy harvesting transmissions, and where the energy harvesting configuration is provided in a first sidelink control channel transmission that is nonspecific to energy harvesting and a second sidelink shared channel transmission that provides one or more energy harvesting parameters, or the energy harvesting configuration is provided in a first sidelink control channel transmission that is specific to energy harvesting.

In some examples, the sidelink communications resource pool includes a first subset of resources for data transmissions and a second subset of resources for the energy harvesting transmissions, and where each of the first subset of resources and the second subset of resources have separate channel sensing parameters, channel busy ratio (CBR) configurations, power control configurations, or any combinations thereof. In some examples, the sidelink communications resource pool includes resources for the energy harvesting transmissions that are scheduled by a network entity or by the first UE. In some examples, the energy harvesting transmissions are wideband transmissions that span frequency resources of one sidelink communications resource pool or two or more frequency division multiplexed sidelink communications resource pools.

In some examples, the energy harvesting transmissions use resources that at least partially overlap in time and frequency with one or more data transmissions, and where the energy harvesting configuration indicates one or more parameters for interference mitigation of the energy harvesting transmissions prior to decoding of the one or more data transmissions. In some examples, one or more resources within the sidelink communications resource pool are selected for the energy harvesting transmissions by the first UE that receives the energy harvesting transmissions, by the second UE that transmits the energy harvesting transmissions, or by a network entity that configures the sidelink communications resource pool.

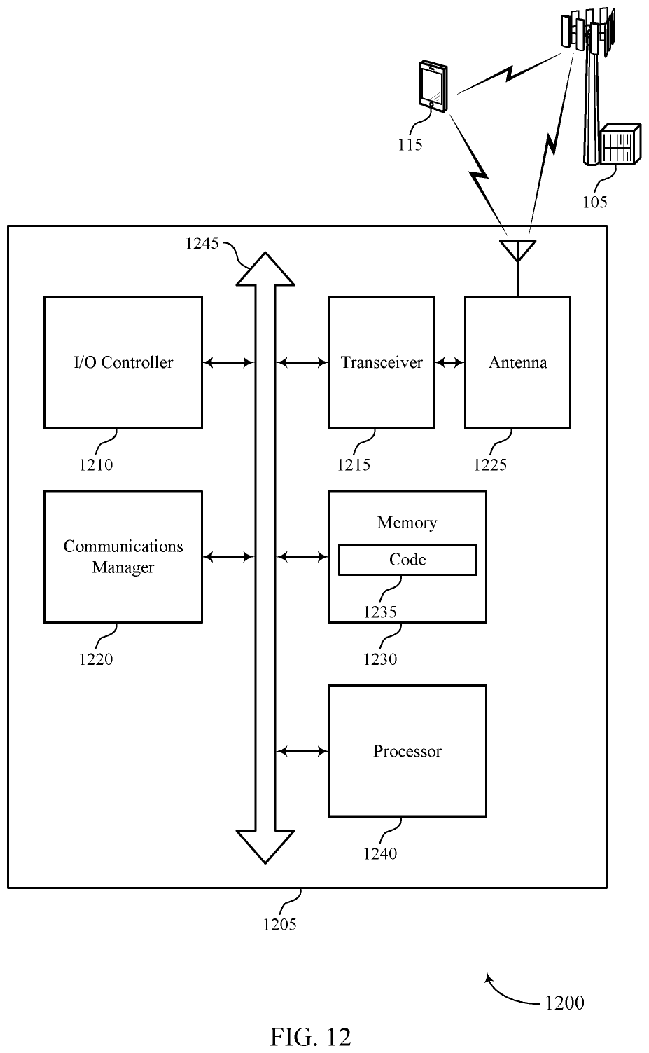

FIG. 12 shows a diagram of a system 1200 including a device 1205 that supports energy transfer configuration for sidelink communications in accordance with one or more aspects of the present disclosure. The device 1205 may be an example of or include the components of a device 905, a device 1005, or a UE 115 as described herein. The device 1205 may communicate (e.g., wirelessly) with one or more network entities 105, one or more UEs 115, or any combination thereof. The device 1205 may include components for bi-directional voice and data communications including components for transmitting and receiving communications, such as a communications manager 1220, an input/output (I/O) controller 1210, a transceiver 1215, an antenna 1225, a memory 1230, code 1235, and a processor 1240. These components may be in electronic communication or otherwise coupled (e.g., operatively, communicatively, functionally, electronically, electrically) via one or more buses (e.g., a bus 1245).

The I/O controller 1210 may manage input and output signals for the device 1205. The I/O controller 1210 may also manage peripherals not integrated into the device 1205. In some cases, the I/O controller 1210 may represent a physical connection or port to an external peripheral. In some cases, the I/O controller 1210 may utilize an operating system such as iOS®, ANDROID®, MS-DOS®, MS-WINDOWS®, OS/2®, UNIX®, LINUX®, or another known operating system. Additionally, or alternatively, the I/O controller 1210 may represent or interact with a modem, a keyboard, a mouse, a touchscreen, or a similar device. In some cases, the I/O controller 1210 may be implemented as part of a processor, such as the processor 1240. In some cases, a user may interact with the device 1205 via the I/O controller 1210 or via hardware components controlled by the I/O controller 1210.

In some cases, the device 1205 may include a single antenna 1225. However, in some other cases, the device 1205 may have more than one antenna 1225, which may be capable of concurrently transmitting or receiving multiple wireless transmissions. The transceiver 1215 may communicate bi-directionally, via the one or more antennas 1225, wired, or wireless links as described herein. For example, the transceiver 1215 may represent a wireless transceiver and may communicate bi-directionally with another wireless transceiver. The transceiver 1215 may also include a modem to modulate the packets, to provide the modulated packets to one or more antennas 1225 for transmission, and to demodulate packets received from the one or more antennas 1225. The transceiver 1215, or the transceiver 1215 and one or more antennas 1225, may be an example of a transmitter 915, a transmitter 1015, a receiver 910, a receiver 1010, or any combination thereof or component thereof, as described herein.

The memory 1230 may include random access memory (RAM) and read-only memory (ROM). The memory 1230 may store computer-readable, computer-executable code 1235 including instructions that, when executed by the processor 1240, cause the device 1205 to perform various functions described herein. The code 1235 may be stored in a non-transitory computer-readable medium such as system memory or another type of memory. In some cases, the code 1235 may not be directly executable by the processor 1240 but may cause a computer (e.g., when compiled and executed) to perform functions described herein. In some cases, the memory 1230 may contain, among other things, a basic I/O system (BIOS) which may control basic hardware or software operation such as the interaction with peripheral components or devices.

The processor 1240 may include an intelligent hardware device (e.g., a general-purpose processor, a DSP, a CPU, a GPU, a microcontroller, an ASIC, an FPGA, a programmable logic device, a discrete gate or transistor logic component, a discrete hardware component, or any combination thereof). In some cases, the processor 1240 may be configured to operate a memory array using a memory controller. In some other cases, a memory controller may be integrated into the processor 1240. The processor 1240 may be configured to execute computer-readable instructions stored in a memory (e.g., the memory 1230) to cause the device 1205 to perform various functions (e.g., functions or tasks supporting energy transfer configuration for sidelink communications). For example, the device 1205 or a component of the device 1205 may include a processor 1240 and memory 1230 coupled with or to the processor 1240, the processor 1240 and memory 1230 configured to perform various functions described herein.

The communications manager 1220 may support wireless communication at a first UE in accordance with examples as disclosed herein. For example, the communications manager 1220 may be configured as or otherwise support a means for receiving control signaling for a sidelink communications resource pool, the control signaling including an energy harvesting configuration for at least a portion of the sidelink communications resource pool, the energy harvesting configuration indicting one or more of a waveform for energy harvesting transmissions or an energy transfer level of the energy harvesting transmissions. The communications manager 1220 may be configured as or otherwise support a means for determining, based on the energy harvesting configuration, one or more energy harvesting parameters for communications with a second UE via the sidelink communications resource pool. The communications manager 1220 may be configured as or otherwise support a means for communicating with the second UE based on the one or more energy harvesting parameters.

By including or configuring the communications manager 1220 in accordance with examples as described herein, the device 1205 may support techniques for efficient indication of energy harvesting resources and associated parameters, which allow for one or more devices to obtain at least a portion of their power to enable communications or prolong operating/battery life of the one or more devices.

In some examples, the communications manager 1220 may be configured to perform various operations (e.g., receiving, monitoring, transmitting) using or otherwise in cooperation with the transceiver 1215, the one or more antennas 1225, or any combination thereof. Although the communications manager 1220 is illustrated as a separate component, in some examples, one or more functions described with reference to the communications manager 1220 may be supported by or performed by the processor 1240, the memory 1230, the code 1235, or any combination thereof. For example, the code 1235 may include instructions executable by the processor 1240 to cause the device 1205 to perform various aspects of energy transfer configuration for sidelink communications as described herein, or the processor 1240 and the memory 1230 may be otherwise configured to perform or support such operations.

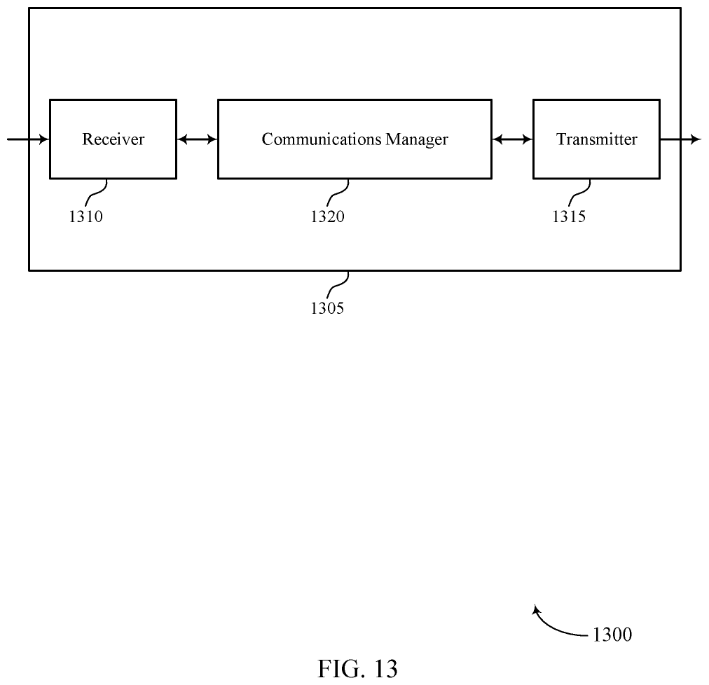

FIG. 13 shows a block diagram 1300 of a device 1305 that supports energy transfer configuration for sidelink communications in accordance with one or more aspects of the present disclosure. The device 1305 may be an example of aspects of a network entity 105 as described herein. The device 1305 may include a receiver 1310, a transmitter 1315, and a communications manager 1320. The device 1305 may also include a processor. Each of these components may be in communication with one another (e.g., via one or more buses).

The receiver 1310 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1305. In some examples, the receiver 1310 may support obtaining information by receiving signals via one or more antennas. Additionally, or alternatively, the receiver 1310 may support obtaining information by receiving signals via one or more wired (e.g., electrical, fiber optic) interfaces, wireless interfaces, or any combination thereof.

The transmitter 1315 may provide a means for outputting (e.g., transmitting, providing, conveying, sending) information generated by other components of the device 1305. For example, the transmitter 1315 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1315 may support outputting information by transmitting signals via one or more antennas. Additionally, or alternatively, the transmitter 1315 may support outputting information by transmitting signals via one or more wired (e.g., electrical, fiber optic) interfaces, wireless interfaces, or any combination thereof. In some examples, the transmitter 1315 and the receiver 1310 may be co-located in a transceiver, which may include or be coupled with a modem.

The communications manager 1320, the receiver 1310, the transmitter 1315, or various combinations thereof or various components thereof may be examples of means for performing various aspects of energy transfer configuration for sidelink communications as described herein. For example, the communications manager 1320, the receiver 1310, the transmitter 1315, or various combinations or components thereof may support a method for performing one or more of the functions described herein.

In some examples, the communications manager 1320, the receiver 1310, the transmitter 1315, or various combinations or components thereof may be implemented in hardware (e.g., in communications management circuitry). The hardware may include a processor, a DSP, a CPU, a GPU, an ASIC, an FPGA or other programmable logic device, a microcontroller, discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally, or alternatively, in some examples, the communications manager 1320, the receiver 1310, the transmitter 1315, or various combinations or components thereof may be implemented in code (e.g., as communications management software) executed by a processor. If implemented in code executed by a processor, the functions of the communications manager 1320, the receiver 1310, the transmitter 1315, or various combinations or components thereof may be performed by a general-purpose processor, a DSP, a CPU, a GPU, an ASIC, an FPGA, a microcontroller, or any combination of these or other programmable logic devices (e.g., configured as or otherwise supporting a means for performing the functions described in the present disclosure).

In some examples, the communications manager 1320 may be configured to perform various operations (e.g., receiving, obtaining, monitoring, outputting, transmitting) using or otherwise in cooperation with the receiver 1310, the transmitter 1315, or both. For example, the communications manager 1320 may receive information from the receiver 1310, send information to the transmitter 1315, or be integrated in combination with the receiver 1310, the transmitter 1315, or both to obtain information, output information, or perform various other operations as described herein.

The communications manager 1320 may support wireless communication at a network entity in accordance with examples as disclosed herein. For example, the communications manager 1320 may be configured as or otherwise support a means for identifying at least a first UE and a second UE for sidelink communications. The communications manager 1320 may be configured as or otherwise support a means for transmitting control signaling to at least the first UE and the second UE for a sidelink communications resource pool, the control signaling including one or more energy harvesting configurations that are available for at least a portion of the sidelink communications resource pool, the one or more energy harvesting configurations indicting one or more of a waveform for energy harvesting transmissions or an energy transfer level of the energy harvesting transmissions.

By including or configuring the communications manager 1320 in accordance with examples as described herein, the device 1305 (e.g., a processor controlling or otherwise coupled with the receiver 1310, the transmitter 1315, the communications manager 1320, or a combination thereof) may support techniques for efficient indication of energy harvesting resources and associated parameters, which allow for one or more devices to obtain at least a portion of their power to enable communications or prolong operating/battery life of the one or more devices.

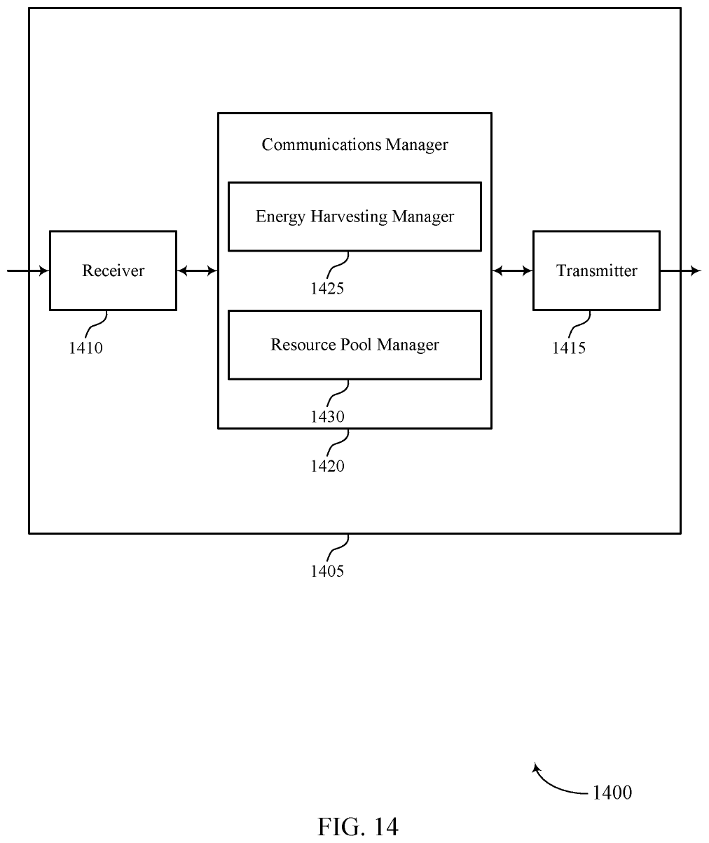

FIG. 14 shows a block diagram 1400 of a device 1405 that supports energy transfer configuration for sidelink communications in accordance with one or more aspects of the present disclosure. The device 1405 may be an example of aspects of a device 1305 or a network entity 105 as described herein. The device 1405 may include a receiver 1410, a transmitter 1415, and a communications manager 1420. The device 1405 may also include a processor. Each of these components may be in communication with one another (e.g., via one or more buses).

The receiver 1410 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1405. In some examples, the receiver 1410 may support obtaining information by receiving signals via one or more antennas. Additionally, or alternatively, the receiver 1410 may support obtaining information by receiving signals via one or more wired (e.g., electrical, fiber optic) interfaces, wireless interfaces, or any combination thereof.

The transmitter 1415 may provide a means for outputting (e.g., transmitting, providing, conveying, sending) information generated by other components of the device 1405. For example, the transmitter 1415 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1415 may support outputting information by transmitting signals via one or more antennas. Additionally, or alternatively, the transmitter 1415 may support outputting information by transmitting signals via one or more wired (e.g., electrical, fiber optic) interfaces, wireless interfaces, or any combination thereof. In some examples, the transmitter 1415 and the receiver 1410 may be co-located in a transceiver, which may include or be coupled with a modem.

The device 1405, or various components thereof, may be an example of means for performing various aspects of energy transfer configuration for sidelink communications as described herein. For example, the communications manager 1420 may include an energy harvesting manager 1425 a resource pool manager 1430, or any combination thereof. The communications manager 1420 may be an example of aspects of a communications manager 1320 as described herein. In some examples, the communications manager 1420, or various components thereof, may be configured to perform various operations (e.g., receiving, obtaining, monitoring, outputting, transmitting) using or otherwise in cooperation with the receiver 1410, the transmitter 1415, or both. For example, the communications manager 1420 may receive information from the receiver 1410, send information to the transmitter 1415, or be integrated in combination with the receiver 1410, the transmitter 1415, or both to obtain information, output information, or perform various other operations as described herein.

The communications manager 1420 may support wireless communication at a network entity in accordance with examples as disclosed herein. The energy harvesting manager 1425 may be configured as or otherwise support a means for identifying at least a first UE and a second UE for sidelink communications. The resource pool manager 1430 may be configured as or otherwise support a means for transmitting control signaling to at least the first UE and the second UE for a sidelink communications resource pool, the control signaling including one or more energy harvesting configurations that are available for at least a portion of the sidelink communications resource pool, the one or more energy harvesting configurations indicting one or more of a waveform for energy harvesting transmissions or an energy transfer level of the energy harvesting transmissions.

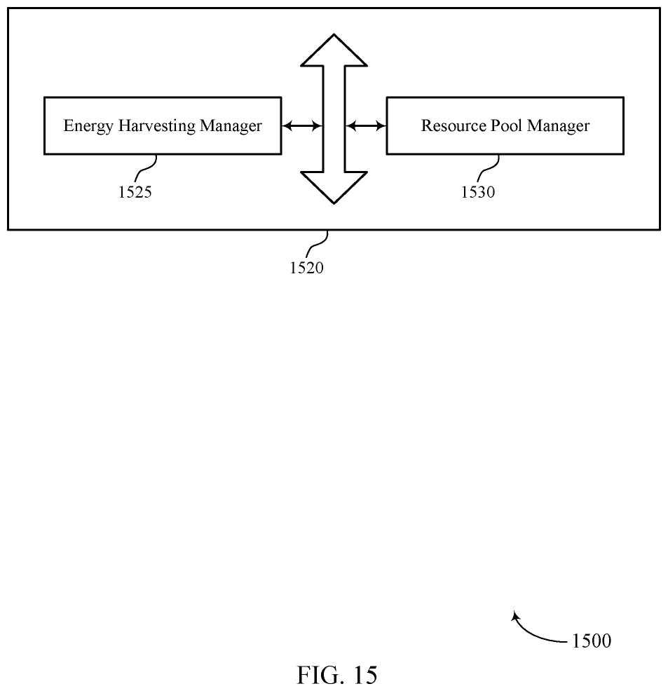

FIG. 15 shows a block diagram 1500 of a communications manager 1520 that supports energy transfer configuration for sidelink communications in accordance with one or more aspects of the present disclosure. The communications manager 1520 may be an example of aspects of a communications manager 1320, a communications manager 1420, or both, as described herein. The communications manager 1520, or various components thereof, may be an example of means for performing various aspects of energy transfer configuration for sidelink communications as described herein. For example, the communications manager 1520 may include an energy harvesting manager 1525 a resource pool manager 1530, or any combination thereof. Each of these components may communicate, directly or indirectly, with one another (e.g., via one or more buses) which may include communications within a protocol layer of a protocol stack, communications associated with a logical channel of a protocol stack (e.g., between protocol layers of a protocol stack, within a device, component, or virtualized component associated with a network entity 105, between devices, components, or virtualized components associated with a network entity 105), or any combination thereof.

The communications manager 1520 may support wireless communication at a network entity in accordance with examples as disclosed herein. The energy harvesting manager 1525 may be configured as or otherwise support a means for identifying at least a first UE and a second UE for sidelink communications. The resource pool manager 1530 may be configured as or otherwise support a means for transmitting control signaling to at least the first UE and the second UE for a sidelink communications resource pool, the control signaling including one or more energy harvesting configurations that are available for at least a portion of the sidelink communications resource pool, the one or more energy harvesting configurations indicting one or more of a waveform for energy harvesting transmissions or an energy transfer level of the energy harvesting transmissions.

In some examples, the one or more energy harvesting configurations include two or more waveforms for the energy harvesting transmissions that are selectable based on a target amount of energy to be transferred in the energy harvesting transmissions. In some examples, the sidelink communications resource pool includes a set of sidelink resources, and where all resources of the set of sidelink resources are allocated for the energy harvesting transmissions or a subset of the set of sidelink resources are allocated for the energy harvesting transmissions. In some examples, each of the one or more energy harvesting configurations indicates one or more of a charging rate, a waveform type of the energy harvesting transmissions, a portion of the sidelink communications resource pool that is allocated for the energy harvesting transmissions, or any combinations thereof.

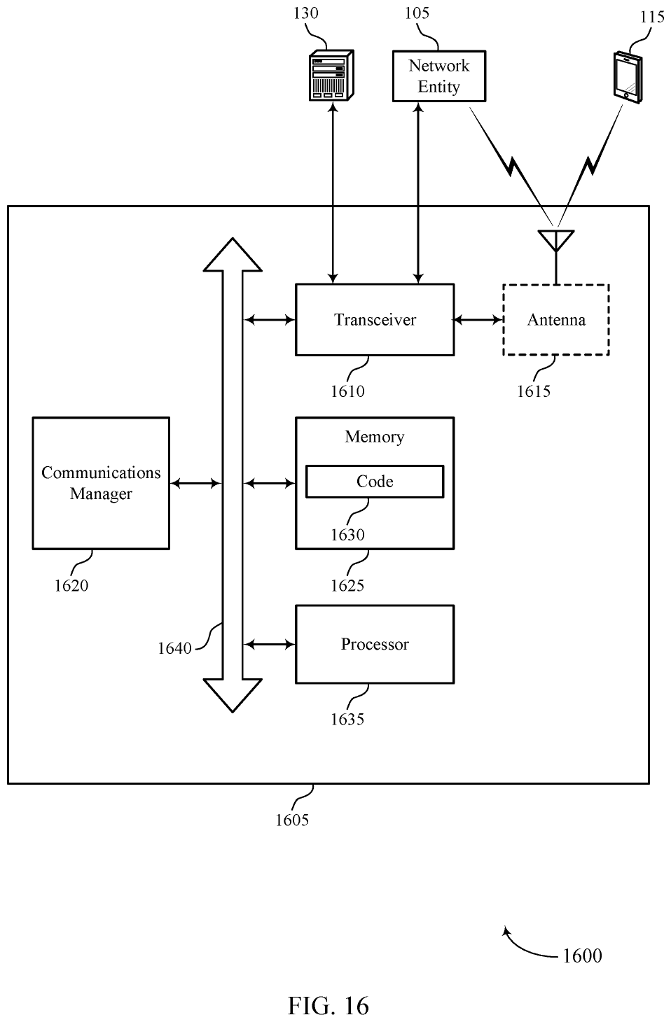

FIG. 16 shows a diagram of a system 1600 including a device 1605 that supports energy transfer configuration for sidelink communications in accordance with one or more aspects of the present disclosure. The device 1605 may be an example of or include the components of a device 1305, a device 1405, or a network entity 105 as described herein. The device 1605 may communicate with one or more network entities 105, one or more UEs 115, or any combination thereof, which may include communications over one or more wired interfaces, over one or more wireless interfaces, or any combination thereof. The device 1605 may include components that support outputting and obtaining communications, such as a communications manager 1620, a transceiver 1610, an antenna 1615, a memory 1625, code 1630, and a processor 1635. These components may be in electronic communication or otherwise coupled (e.g., operatively, communicatively, functionally, electronically, electrically) via one or more buses (e.g., a bus 1640).

The transceiver 1610 may support bi-directional communications via wired links, wireless links, or both as described herein. In some examples, the transceiver 1610 may include a wired transceiver and may communicate bi-directionally with another wired transceiver. Additionally, or alternatively, in some examples, the transceiver 1610 may include a wireless transceiver and may communicate bi-directionally with another wireless transceiver. In some examples, the device 1605 may include one or more antennas 1615, which may be capable of transmitting or receiving wireless transmissions (e.g., concurrently). The transceiver 1610 may also include a modem to modulate signals, to provide the modulated signals for transmission (e.g., by one or more antennas 1615, by a wired transmitter), to receive modulated signals (e.g., from one or more antennas 1615, from a wired receiver), and to demodulate signals. The transceiver 1610, or the transceiver 1610 and one or more antennas 1615 or wired interfaces, where applicable, may be an example of a transmitter 1315, a transmitter 1415, a receiver 1310, a receiver 1410, or any combination thereof or component thereof, as described herein. In some examples, the transceiver may be operable to support communications via one or more communications links (e.g., a communication link 125, a backhaul communication link 120, a midhaul communication link 162, a fronthaul communication link 168).

The memory 1625 may include RAM and ROM. The memory 1625 may store computer-readable, computer-executable code 1630 including instructions that, when executed by the processor 1635, cause the device 1605 to perform various functions described herein. The code 1630 may be stored in a non-transitory computer-readable medium such as system memory or another type of memory. In some cases, the code 1630 may not be directly executable by the processor 1635 but may cause a computer (e.g., when compiled and executed) to perform functions described herein. In some cases, the memory 1625 may contain, among other things, a BIOS which may control basic hardware or software operation such as the interaction with peripheral components or devices.

The processor 1635 may include an intelligent hardware device (e.g., a general-purpose processor, a DSP, an ASIC, a CPU, a GPU, an FPGA, a microcontroller, a programmable logic device, discrete gate or transistor logic, a discrete hardware component, or any combination thereof). In some cases, the processor 1635 may be configured to operate a memory array using a memory controller. In some other cases, a memory controller may be integrated into the processor 1635. The processor 1635 may be configured to execute computer-readable instructions stored in a memory (e.g., the memory 1625) to cause the device 1605 to perform various functions (e.g., functions or tasks supporting energy transfer configuration for sidelink communications). For example, the device 1605 or a component of the device 1605 may include a processor 1635 and memory 1625 coupled with the processor 1635, the processor 1635 and memory 1625 configured to perform various functions described herein. The processor 1635 may be an example of a cloud-computing platform (e.g., one or more physical nodes and supporting software such as operating systems, virtual machines, or container instances) that may host the functions (e.g., by executing code 1630) to perform the functions of the device 1605.

In some examples, a bus 1640 may support communications of (e.g., within) a protocol layer of a protocol stack. In some examples, a bus 1640 may support communications associated with a logical channel of a protocol stack (e.g., between protocol layers of a protocol stack), which may include communications performed within a component of the device 1605, or between different components of the device 1605 that may be co-located or located in different locations (e.g., where the device 1605 may refer to a system in which one or more of the communications manager 1620, the transceiver 1610, the memory 1625, the code 1630, and the processor 1635 may be located in one of the different components or divided between different components).

In some examples, the communications manager 1620 may manage aspects of communications with a core network 130 (e.g., via one or more wired or wireless backhaul links). For example, the communications manager 1620 may manage the transfer of data communications for client devices, such as one or more UEs 115. In some examples, the communications manager 1620 may manage communications with other network entities 105, and may include a controller or scheduler for controlling communications with UEs 115 in cooperation with other network entities 105. In some examples, the communications manager 1620 may support an X2 interface within an LTE/LTE-A wireless communications network technology to provide communication between network entities 105.

The communications manager 1620 may support wireless communication at a network entity in accordance with examples as disclosed herein. For example, the communications manager 1620 may be configured as or otherwise support a means for identifying at least a first UE and a second UE for sidelink communications. The communications manager 1620 may be configured as or otherwise support a means for transmitting control signaling to at least the first UE and the second UE for a sidelink communications resource pool, the control signaling including one or more energy harvesting configurations that are available for at least a portion of the sidelink communications resource pool, the one or more energy harvesting configurations indicting one or more of a waveform for energy harvesting transmissions or an energy transfer level of the energy harvesting transmissions.

By including or configuring the communications manager 1620 in accordance with examples as described herein, the device 1605 may support techniques for efficient indication of energy harvesting resources and associated parameters, which allow for one or more devices to obtain at least a portion of their power to enable communications or prolong operating/battery life of the one or more devices.

In some examples, the communications manager 1620 may be configured to perform various operations (e.g., receiving, obtaining, monitoring, outputting, transmitting) using or otherwise in cooperation with the transceiver 1610, the one or more antennas 1615 (e.g., where applicable), or any combination thereof. Although the communications manager 1620 is illustrated as a separate component, in some examples, one or more functions described with reference to the communications manager 1620 may be supported by or performed by the processor 1635, the memory 1625, the code 1630, the transceiver 1610, or any combination thereof. For example, the code 1630 may include instructions executable by the processor 1635 to cause the device 1605 to perform various aspects of energy transfer configuration for sidelink communications as described herein, or the processor 1635 and the memory 1625 may be otherwise configured to perform or support such operations.

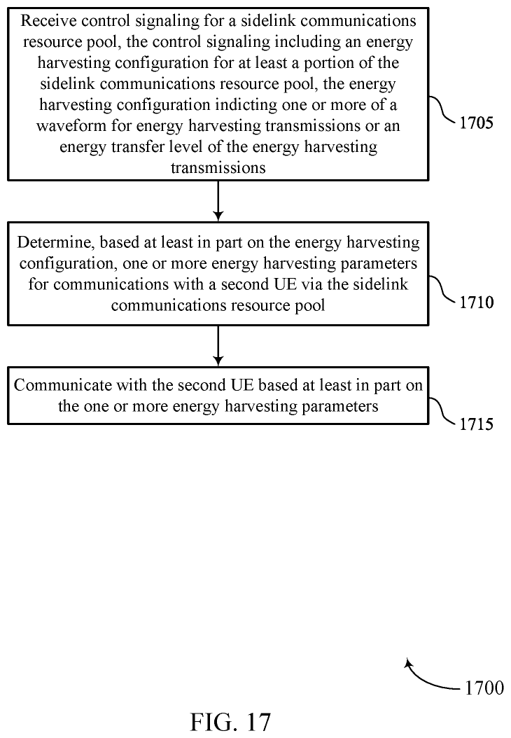

FIG. 17 shows a flowchart illustrating a method 1700 that supports energy transfer configuration for sidelink communications in accordance with one or more aspects of the present disclosure. The operations of the method 1700 may be implemented by a UE or its components as described herein. For example, the operations of the method 1700 may be performed by a UE 115 as described with reference to FIGS. 1 through 12. In some examples, a UE may execute a set of instructions to control the functional elements of the UE to perform the described functions. Additionally, or alternatively, the UE may perform aspects of the described functions using special-purpose hardware.

At 1705, the method may include receiving control signaling for a sidelink communications resource pool, the control signaling including an energy harvesting configuration for at least a portion of the sidelink communications resource pool, the energy harvesting configuration indicting one or more of a waveform for energy harvesting transmissions or an energy transfer level of the energy harvesting transmissions. The operations of 1705 may be performed in accordance with examples as disclosed herein. In some examples, aspects of the operations of 1705 may be performed by a resource pool manager 1125 as described with reference to FIG. 11.

At 1710, the method may include determining, based at least in part on the energy harvesting configuration, one or more energy harvesting parameters for communications with a second UE via the sidelink communications resource pool. The operations of 1710 may be performed in accordance with examples as disclosed herein. In some examples, aspects of the operations of 1710 may be performed by an energy harvesting manager 1130 as described with reference to FIG. 11.

At 1715, the method may include communicating with the second UE based at least in part on the one or more energy harvesting parameters. The operations of 1715 may be performed in accordance with examples as disclosed herein. In some examples, aspects of the operations of 1715 may be performed by a communications manager 1135 as described with reference to FIG. 11.

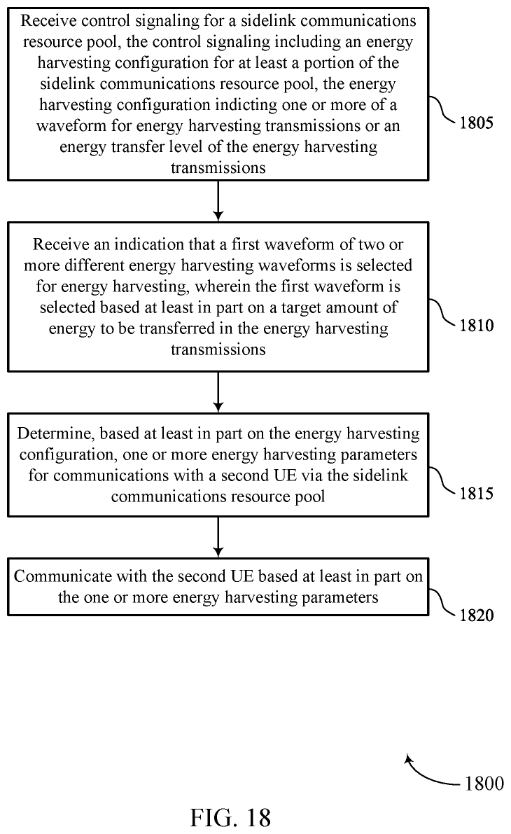

FIG. 18 shows a flowchart illustrating a method 1800 that supports energy transfer configuration for sidelink communications in accordance with one or more aspects of the present disclosure. The operations of the method 1800 may be implemented by a UE or its components as described herein. For example, the operations of the method 1800 may be performed by a UE 115 as described with reference to FIGS. 1 through 12. In some examples, a UE may execute a set of instructions to control the functional elements of the UE to perform the described functions. Additionally, or alternatively, the UE may perform aspects of the described functions using special-purpose hardware.

At 1805, the method may include receiving control signaling for a sidelink communications resource pool, the control signaling including an energy harvesting configuration for at least a portion of the sidelink communications resource pool, the energy harvesting configuration indicting one or more of a waveform for energy harvesting transmissions or an energy transfer level of the energy harvesting transmissions. The operations of 1805 may be performed in accordance with examples as disclosed herein. In some examples, aspects of the operations of 1805 may be performed by a resource pool manager 1125 as described with reference to FIG. 11.

At 1810, the method may include receiving an indication that a first waveform of two or more different energy harvesting waveforms is selected for energy harvesting, where the first waveform is selected based at least in part on a target amount of energy to be transferred in the energy harvesting transmissions. The operations of 1810 may be performed in accordance with examples as disclosed herein. In some examples, aspects of the operations of 1810 may be performed by an energy harvesting manager 1130 as described with reference to FIG. 11.

At 1815, the method may include determining, based at least in part on the energy harvesting configuration, one or more energy harvesting parameters for communications with a second UE via the sidelink communications resource pool. The operations of 1815 may be performed in accordance with examples as disclosed herein. In some examples, aspects of the operations of 1815 may be performed by an energy harvesting manager 1130 as described with reference to FIG. 11.

At 1820, the method may include communicating with the second UE based at least in part on the one or more energy harvesting parameters. The operations of 1820 may be performed in accordance with examples as disclosed herein. In some examples, aspects of the operations of 1820 may be performed by a communications manager 1135 as described with reference to FIG. 11.

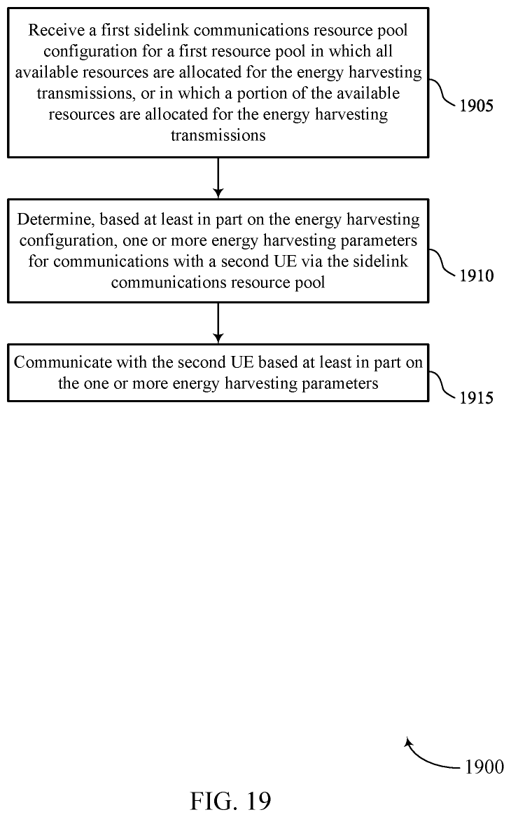

FIG. 19 shows a flowchart illustrating a method 1900 that supports energy transfer configuration for sidelink communications in accordance with one or more aspects of the present disclosure. The operations of the method 1900 may be implemented by a UE or its components as described herein. For example, the operations of the method 1900 may be performed by a UE 115 as described with reference to FIGS. 1 through 12. In some examples, a UE may execute a set of instructions to control the functional elements of the UE to perform the described functions. Additionally, or alternatively, the UE may perform aspects of the described functions using special-purpose hardware.

At 1905, the method may include receiving a first sidelink communications resource pool configuration for a first resource pool in which all available resources are allocated for the energy harvesting transmissions, or in which a portion of the available resources are allocated for the energy harvesting transmissions. In some cases, the configuration may indicate one or more of a waveform for energy harvesting transmissions or an energy transfer level of the energy harvesting transmissions. The operations of 1905 may be performed in accordance with examples as disclosed herein. In some examples, aspects of the operations of 1905 may be performed by a resource pool manager 1125 as described with reference to FIG. 11.

At 1910, the method may include determining, based at least in part on the energy harvesting configuration, one or more energy harvesting parameters for communications with a second UE via the sidelink communications resource pool. The operations of 1910 may be performed in accordance with examples as disclosed herein. In some examples, aspects of the operations of 1910 may be performed by an energy harvesting manager 1130 as described with reference to FIG. 11.

At 1915, the method may include communicating with the second UE based at least in part on the one or more energy harvesting parameters. The operations of 1915 may be performed in accordance with examples as disclosed herein. In some examples, aspects of the operations of 1915 may be performed by a communications manager 1135 as described with reference to FIG. 11.

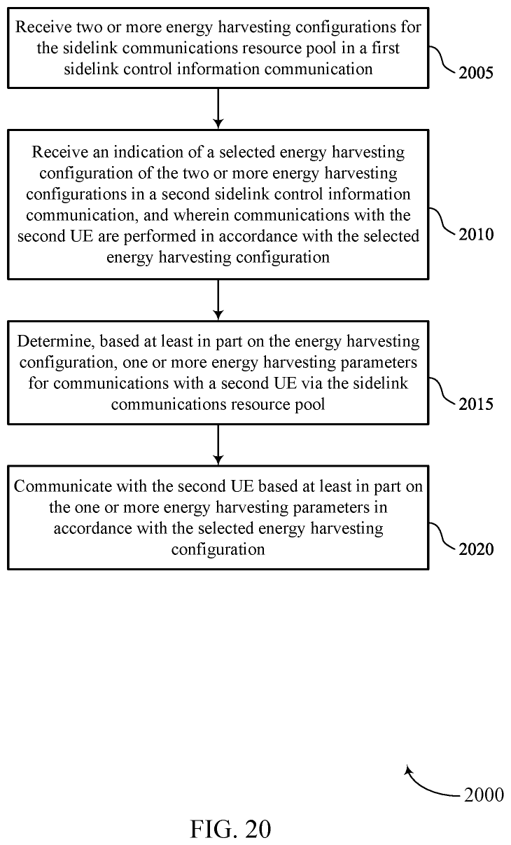

FIG. 20 shows a flowchart illustrating a method 2000 that supports energy transfer configuration for sidelink communications in accordance with one or more aspects of the present disclosure. The operations of the method 2000 may be implemented by a UE or its components as described herein. For example, the operations of the method 2000 may be performed by a UE 115 as described with reference to FIGS. 1 through 12. In some examples, a UE may execute a set of instructions to control the functional elements of the UE to perform the described functions. Additionally, or alternatively, the UE may perform aspects of the described functions using special-purpose hardware.

At 2005, the method may include receiving two or more energy harvesting configurations for the sidelink communications resource pool in a first sidelink control information communication. In some cases, each energy harvesting configuration may indicate one or more of a waveform for energy harvesting transmissions or an energy transfer level of the energy harvesting transmissions. The operations of 2005 may be performed in accordance with examples as disclosed herein. In some examples, aspects of the operations of 2005 may be performed by an energy harvesting manager 1130 as described with reference to FIG. 11.

At 2010, the method may include receiving an indication of a selected energy harvesting configuration of the two or more energy harvesting configurations in a second sidelink control information communication. The operations of 2010 may be performed in accordance with examples as disclosed herein. In some examples, aspects of the operations of 2010 may be performed by an energy harvesting manager 1130 as described with reference to FIG. 11.

At 2015, the method may include determining, based at least in part on the energy harvesting configuration, one or more energy harvesting parameters for communications with a second UE via the sidelink communications resource pool. The operations of 2015 may be performed in accordance with examples as disclosed herein. In some examples, aspects of the operations of 2015 may be performed by an energy harvesting manager 1130 as described with reference to FIG. 11.

At 2020, the method may include communicating with the second UE based at least in part on the one or more energy harvesting parameters in accordance with the selected energy harvesting configuration. The operations of 2020 may be performed in accordance with examples as disclosed herein. In some examples, aspects of the operations of 2020 may be performed by a communications manager 1135 as described with reference to FIG. 11.

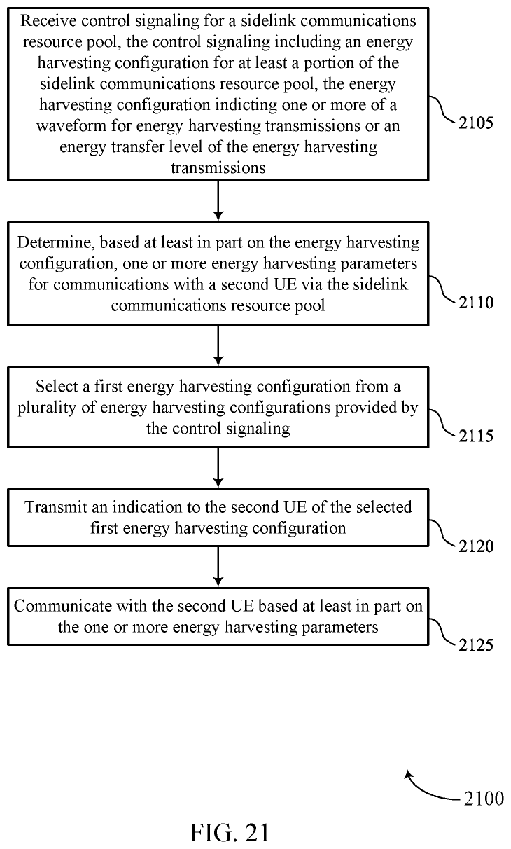

FIG. 21 shows a flowchart illustrating a method 2100 that supports energy transfer configuration for sidelink communications in accordance with one or more aspects of the present disclosure. The operations of the method 2100 may be implemented by a UE or its components as described herein. For example, the operations of the method 2100 may be performed by a UE 115 as described with reference to FIGS. 1 through 12. In some examples, a UE may execute a set of instructions to control the functional elements of the UE to perform the described functions. Additionally, or alternatively, the UE may perform aspects of the described functions using special-purpose hardware.

At 2105, the method may include receiving control signaling for a sidelink communications resource pool, the control signaling including an energy harvesting configuration for at least a portion of the sidelink communications resource pool, the energy harvesting configuration indicting one or more of a waveform for energy harvesting transmissions or an energy transfer level of the energy harvesting transmissions. The operations of 2105 may be performed in accordance with examples as disclosed herein. In some examples, aspects of the operations of 2105 may be performed by a resource pool manager 1125 as described with reference to FIG. 11.

At 2110, the method may include determining, based at least in part on the energy harvesting configuration, one or more energy harvesting parameters for communications with a second UE via the sidelink communications resource pool. The operations of 2110 may be performed in accordance with examples as disclosed herein. In some examples, aspects of the operations of 2110 may be performed by an energy harvesting manager 1130 as described with reference to FIG. 11.

At 2115, the method may include selecting a first energy harvesting configuration from a set of multiple energy harvesting configurations provided by the control signaling. The operations of 2115 may be performed in accordance with examples as disclosed herein. In some examples, aspects of the operations of 2115 may be performed by an energy harvesting manager 1130 as described with reference to FIG. 11.

At 2120, the method may include transmitting an indication to the second UE of the selected first energy harvesting configuration. The operations of 2120 may be performed in accordance with examples as disclosed herein. In some examples, aspects of the operations of 2120 may be performed by an energy harvesting manager 1130 as described with reference to FIG. 11.

At 2125, the method may include communicating with the second UE based at least in part on the one or more energy harvesting parameters. The operations of 2125 may be performed in accordance with examples as disclosed herein. In some examples, aspects of the operations of 2125 may be performed by a communications manager 1135 as described with reference to FIG. 11.

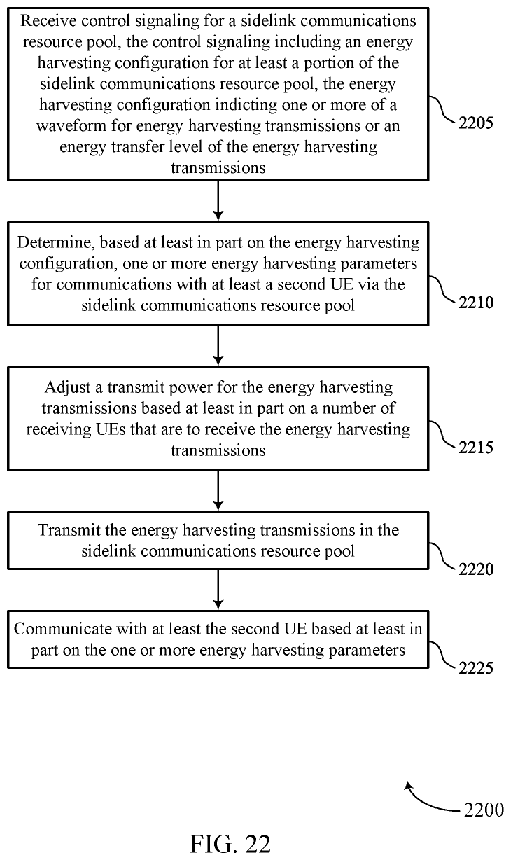

FIG. 22 shows a flowchart illustrating a method 2200 that supports energy transfer configuration for sidelink communications in accordance with one or more aspects of the present disclosure. The operations of the method 2200 may be implemented by a UE or its components as described herein. For example, the operations of the method 2200 may be performed by a UE 115 as described with reference to FIGS. 1 through 12. In some examples, a UE may execute a set of instructions to control the functional elements of the UE to perform the described functions. Additionally, or alternatively, the UE may perform aspects of the described functions using special-purpose hardware.

At 2205, the method may include receiving control signaling for a sidelink communications resource pool, the control signaling including an energy harvesting configuration for at least a portion of the sidelink communications resource pool, the energy harvesting configuration indicting one or more of a waveform for energy harvesting transmissions or an energy transfer level of the energy harvesting transmissions. The operations of 2205 may be performed in accordance with examples as disclosed herein. In some examples, aspects of the operations of 2205 may be performed by a resource pool manager 1125 as described with reference to FIG. 11.

At 2210, the method may include determining, based at least in part on the energy harvesting configuration, one or more energy harvesting parameters for communications with at least a second UE via the sidelink communications resource pool. The operations of 2210 may be performed in accordance with examples as disclosed herein. In some examples, aspects of the operations of 2210 may be performed by an energy harvesting manager 1130 as described with reference to FIG. 11.

At 2215, the method may include adjusting a transmit power for the energy harvesting transmissions based at least in part on a number of receiving UEs that are to receive the energy harvesting transmissions. The operations of 2215 may be performed in accordance with examples as disclosed herein. In some examples, aspects of the operations of 2215 may be performed by a transmit power manager 1145 as described with reference to FIG. 11.

At 2220, the method may include transmitting the energy harvesting transmissions in the sidelink communications resource pool. The operations of 2220 may be performed in accordance with examples as disclosed herein. In some examples, aspects of the operations of 2220 may be performed by a communications manager 1135 as described with reference to FIG. 11.

At 2225, the method may include communicating with at least the second UE based at least in part on the one or more energy harvesting parameters. The operations of 2225 may be performed in accordance with examples as disclosed herein. In some examples, aspects of the operations of 2225 may be performed by a communications manager 1135 as described with reference to FIG. 11.

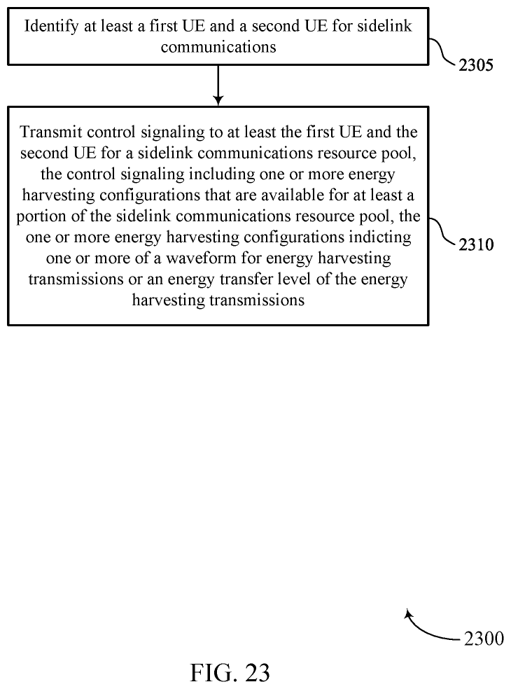

FIG. 23 shows a flowchart illustrating a method 2300 that supports energy transfer configuration for sidelink communications in accordance with one or more aspects of the present disclosure. The operations of the method 2300 may be implemented by a network entity or its components as described herein. For example, the operations of the method 2300 may be performed by a network entity as described with reference to FIGS. 1 through 8 and 13 through 16. In some examples, a network entity may execute a set of instructions to control the functional elements of the network entity to perform the described functions. Additionally, or alternatively, the network entity may perform aspects of the described functions using special-purpose hardware.

At 2305, the method may include identifying at least a first UE and a second UE for sidelink communications. The operations of 2305 may be performed in accordance with examples as disclosed herein. In some examples, aspects of the operations of 2305 may be performed by an energy harvesting manager 1525 as described with reference to FIG. 15.

At 2310, the method may include transmitting control signaling to at least the first UE and the second UE for a sidelink communications resource pool, the control signaling including one or more energy harvesting configurations that are available for at least a portion of the sidelink communications resource pool, the one or more energy harvesting configurations indicting one or more of a waveform for energy harvesting transmissions or an energy transfer level of the energy harvesting transmissions. The operations of 2310 may be performed in accordance with examples as disclosed herein. In some examples, aspects of the operations of 2310 may be performed by a resource pool manager 1530 as described with reference to FIG. 15.

The following provides an overview of aspects of the present disclosure:

Aspect 1: A method for wireless communication at a first UE, comprising: receiving control signaling for a sidelink communications resource pool, the control signaling including an energy harvesting configuration for at least a portion of the sidelink communications resource pool, the energy harvesting configuration indicting one or more of a waveform for energy harvesting transmissions or an energy transfer level of the energy harvesting transmissions: determining, based at least in part on the energy harvesting configuration, one or more energy harvesting parameters for communications with a second UE via the sidelink communications resource pool; and communicating with the second UE based at least in part on the one or more energy harvesting parameters.

Aspect 2: The method of aspect 1, wherein the receiving the control signaling comprises: receiving an indication that a first waveform of two or more different energy harvesting waveforms is selected for energy harvesting, wherein the first waveform is selected based at least in part on a target amount of energy to be transferred in the energy harvesting transmissions.

Aspect 3: The method of any of aspects 1 through 2, wherein the receiving the control signaling comprises: receiving a first sidelink communications resource pool configuration for a first resource pool in which all available resources are allocated for the energy harvesting transmissions, or in which a portion of the available resources are allocated for the energy harvesting transmissions.

Aspect 4: The method of any of aspects 1 through 3, wherein the control signaling for two or more sidelink communications resource pools is provided by a network entity that configures sidelink communications between the first UE and the second UE, and wherein at least one of the two or more sidelink communications resource pools includes the energy harvesting configuration.

Aspect 5: The method of any of aspects 1 through 4, wherein the energy harvesting configuration indicates one or more of a charging rate associated with the energy harvesting transmissions, a waveform type of the energy harvesting transmissions, a portion of the sidelink communications resource pool that is allocated for the energy harvesting transmissions, or any combinations thereof.

Aspect 6: The method of any of aspects 1 through 5, wherein the sidelink communications resource pool includes at least a first bandwidth part for the energy harvesting transmissions and a second bandwidth part for data communications, and wherein the first bandwidth part and second bandwidth part have separately configured subcarrier spacing, frequency locations, or any combinations thereof.

Aspect 7: The method of any of aspects 1 through 6, wherein the receiving the control signaling comprises: receiving two or more energy harvesting configurations for the sidelink communications resource pool in a first sidelink control information communication; and receiving an indication of a selected energy harvesting configuration of the two or more energy harvesting configurations in a second sidelink control information communication, and wherein communications with the second UE are performed in accordance with the selected energy harvesting configuration.

Aspect 8: The method of any of aspects 1 through 7, wherein the sidelink communications resource pool is a first sidelink communications resource pool having the energy harvesting configuration, and the control signaling is received in a second sidelink communications resource pool that is different than the first sidelink communications resource pool.

Aspect 9: The method of aspect 8, wherein the first sidelink communications resource pool provides resources for the energy harvesting transmissions only, without resources for automatic gain control.

Aspect 10: The method of any of aspects 1 through 9, wherein the control signaling is received prior to the energy harvesting transmissions, and indicates resources of the sidelink communications resource pool that are reserved for the energy harvesting transmissions.

Aspect 11: The method of any of aspects 1 through 10, wherein the receiving comprises: receiving energy-harvesting-specific sidelink control information that indicates the waveform for the energy harvesting transmissions and the energy transfer level for the energy harvesting transmissions.

Aspect 12: The method of any of aspects 1 through 11, further comprising: selecting a first energy harvesting configuration from a plurality of energy harvesting configurations provided by the control signaling; and transmitting an indication to the second UE of the selected first energy harvesting configuration.

Aspect 13: The method of any of aspects 1 through 12, further comprising: adjusting a transmit power for the energy harvesting transmissions based at least in part on a number of receiving UEs that are to receive the energy harvesting transmissions; and transmitting the energy harvesting transmissions in the sidelink communications resource pool.

Aspect 14: The method of any of aspects 1 through 13, wherein the sidelink communications resource pool is configured for both data transmissions and the energy harvesting transmissions, and wherein the energy harvesting configuration indicates one or more time switching parameters or power splitting parameters for the data transmissions and the energy harvesting transmissions.

Aspect 15: The method of any of aspects 1 through 13, wherein the sidelink communications resource pool is configured for only the energy harvesting transmissions, and wherein the energy harvesting configuration is provided in a first sidelink control channel transmission that is nonspecific to energy harvesting and a second sidelink shared channel transmission that provides one or more energy harvesting parameters, or the energy harvesting configuration is provided in a first sidelink control channel transmission that is specific to energy harvesting.

Aspect 16: The method of any of aspects 1 through 14, wherein the sidelink communications resource pool includes a first subset of resources for data transmissions and a second subset of resources for the energy harvesting transmissions, and wherein each of the first subset of resources and the second subset of resources have separate channel sensing parameters, channel busy ratio (CBR) configurations, power control configurations, or any combinations thereof.

Aspect 17: The method of any of aspects 1 through 16, wherein the sidelink communications resource pool includes resources for the energy harvesting transmissions that are scheduled by a network entity or by the first UE.

Aspect 18: The method of any of aspects 1 through 17, wherein the energy harvesting transmissions are wideband transmissions that span frequency resources of one sidelink communications resource pool or two or more frequency division multiplexed sidelink communications resource pools.

Aspect 19: The method of any of aspects 1 through 14, wherein the energy harvesting transmissions use resources that at least partially overlap in time and frequency with one or more data transmissions, and wherein the energy harvesting configuration indicates one or more parameters for interference mitigation of the energy harvesting transmissions prior to decoding of the one or more data transmissions.

Aspect 20: The method of any of aspects 1 through 19, wherein one or more resources within the sidelink communications resource pool are selected for the energy harvesting transmissions by the first UE that receives the energy harvesting transmissions, by the second UE that transmits the energy harvesting transmissions, or by a network entity that configures the sidelink communications resource pool.

Aspect 21: A method for wireless communication at a network entity, comprising: identifying at least a first UE and a second UE for sidelink communications; and transmitting control signaling to at least the first UE and the second UE for a sidelink communications resource pool, the control signaling including one or more energy harvesting configurations that are available for at least a portion of the sidelink communications resource pool, the one or more energy harvesting configurations indicting one or more of a waveform for energy harvesting transmissions or an energy transfer level of the energy harvesting transmissions.

Aspect 22: The method of aspect 21, wherein the one or more energy harvesting configurations include two or more waveforms for the energy harvesting transmissions that are selectable based at least in part on a target amount of energy to be transferred in the energy harvesting transmissions.

Aspect 23: The method of any of aspects 21 through 22, wherein the sidelink communications resource pool includes a set of sidelink resources, and wherein all resources of the set of sidelink resources are allocated for the energy harvesting transmissions or a subset of the set of sidelink resources are allocated for the energy harvesting transmissions.

Aspect 24: The method of any of aspects 21 through 23, wherein each of the one or more energy harvesting configurations indicates one or more of a charging rate, a waveform type of the energy harvesting transmissions, a portion of the sidelink communications resource pool that is allocated for the energy harvesting transmissions, or any combinations thereof.

Aspect 25: An apparatus for wireless communication at a first UE, comprising at least one processor; and memory coupled to the at least one processor, the memory storing instructions executable by the at least one processor to cause the UE to perform a method of any of aspects 1 through 20.

Aspect 26: An apparatus for wireless communication at a first UE, comprising at least one means for performing a method of any of aspects 1 through 20.

Aspect 27: A non-transitory computer-readable medium storing code for wireless communication at a first UE, the code comprising instructions executable by at least one processor to perform a method of any of aspects 1 through 20.

Aspect 28: An apparatus for wireless communication at a network entity, comprising at least one processor; and memory coupled to the at least one processor, the memory storing instructions executable by the processor to cause the network entity to perform a method of any of aspects 21 through 24.

Aspect 29: An apparatus for wireless communication at a network entity, comprising at least one means for performing a method of any of aspects 21 through 24.

Aspect 30: A non-transitory computer-readable medium storing code for wireless communication at a network entity, the code comprising instructions executable by at least one processor to perform a method of any of aspects 21 through 24.

It should be noted that the methods described herein describe possible implementations, and that the operations and the steps may be rearranged or otherwise modified and that other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies, including future systems and radio technologies, not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed with a general-purpose processor, a DSP, an ASIC, a CPU, a GPU, an FPGA or other programmable logic device, discrete gate or transistor logic, discrete hardware components, or any combination thereof designed to perform the functions described herein. A general-purpose processor may be a microprocessor, but in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by a processor, or any combination thereof. Software shall be construed broadly to mean instructions, instruction sets, code, code segments, program code, programs, subprograms, software modules, applications, software applications, software packages, routines, subroutines, objects, executables, threads of execution, procedures, or functions, whether referred to as software, firmware, middleware, microcode, hardware description language, or otherwise. If implemented in software executed by a processor, the functions may be stored on or transmitted over as one or more instructions or code on a computer-readable medium. Other examples and implementations are within the scope of the disclosure and appended claims. For example, due to the nature of software, functions described herein may be implemented using software executed by a processor, hardware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one place to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, phase change memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.” As used herein, the term “and/or,” when used in a list of two or more items, means that any one of the listed items can be employed by itself, or any combination of two or more of the listed items can be employed. For example, if a composition is described as containing components A, B, and/or C, the composition can contain A alone: B alone: C alone: A and B in combination: A and C in combination; B and C in combination; or A, B, and C in combination.

The term “determine” or “determining” encompasses a variety of actions and, therefore, “determining” can include calculating, computing, processing, deriving, investigating, looking up (such as via looking up in a table, a database or another data structure), ascertaining and the like. Also, “determining” can include receiving (such as receiving information), accessing (such as accessing data in a memory) and the like. Also, “determining” can include resolving, obtaining, selecting, choosing, establishing and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A method for wireless communication at a first user equipment (UE), comprising:
receiving control signaling for a sidelink communications resource pool, the control signaling including an energy harvesting configuration for at least a portion of the sidelink communications resource pool, the energy harvesting configuration indicting one or more of a waveform for energy harvesting transmissions or an energy transfer level of the energy harvesting transmissions:
determining, based at least in part on the energy harvesting configuration, one or more energy harvesting parameters for communications with a second UE via the sidelink communications resource pool; and
communicating with the second UE based at least in part on the one or more energy harvesting parameters.

2. The method of claim 1, wherein the receiving the control signaling comprises:
receiving an indication that a first waveform of two or more different energy harvesting waveforms is selected for energy harvesting, wherein the first waveform is selected based at least in part on a target amount of energy to be transferred in the energy harvesting transmissions.

3. The method of claim 1, wherein the receiving the control signaling comprises:
receiving a first sidelink communications resource pool configuration for a first resource pool in which all available resources are allocated for the energy harvesting transmissions, or in which a portion of the available resources are allocated for the energy harvesting transmissions.

4. The method of claim 1, wherein the control signaling for two or more sidelink communications resource pools is provided by a network entity that configures sidelink communications between the first UE and the second UE, and wherein at least one of the two or more sidelink communications resource pools includes the energy harvesting configuration.

5. The method of claim 1, wherein the energy harvesting configuration indicates one or more of a charging rate associated with the energy harvesting transmissions, a waveform type of the energy harvesting transmissions, a portion of the sidelink communications resource pool that is allocated for the energy harvesting transmissions, or any combinations thereof.

6. The method of claim 1, wherein the sidelink communications resource pool includes at least a first bandwidth part for the energy harvesting transmissions and a second bandwidth part for data communications, and wherein the first bandwidth part and second bandwidth part have separately configured subcarrier spacing, frequency locations, or any combinations thereof.

7. The method of claim 1, wherein the receiving the control signaling comprises:
receiving two or more energy harvesting configurations for the sidelink communications resource pool in a first sidelink control information communication; and
receiving an indication of a selected energy harvesting configuration of the two or more energy harvesting configurations in a second sidelink control information communication, and wherein communications with the second UE are performed in accordance with the selected energy harvesting configuration.

8. The method of claim 1, wherein the sidelink communications resource pool is a first sidelink communications resource pool having the energy harvesting configuration, and the control signaling is received in a second sidelink communications resource pool that is different than the first sidelink communications resource pool.

9. The method of claim 8, wherein the first sidelink communications resource pool provides resources for the energy harvesting transmissions only, without resources for automatic gain control.

10. The method of claim 1, wherein the control signaling is received prior to the energy harvesting transmissions, and indicates resources of the sidelink communications resource pool that are reserved for the energy harvesting transmissions.

11. The method of claim 1, wherein the receiving comprises:
receiving energy-harvesting-specific sidelink control information that indicates the waveform for the energy harvesting transmissions and the energy transfer level for the energy harvesting transmissions.

12. The method of claim 1, further comprising:
selecting a first energy harvesting configuration from a plurality of energy harvesting configurations provided by the control signaling; and
transmitting an indication to the second UE of the selected first energy harvesting configuration.

13. The method of claim 1, further comprising:
adjusting a transmit power for the energy harvesting transmissions based at least in part on a number of receiving UEs that are to receive the energy harvesting transmissions; and
transmitting the energy harvesting transmissions in the sidelink communications resource pool.

14. The method of claim 1, wherein the sidelink communications resource pool is configured for both data transmissions and the energy harvesting transmissions, and wherein the energy harvesting configuration indicates one or more time switching parameters or power splitting parameters for the data transmissions and the energy harvesting transmissions.

15. The method of claim 1, wherein the sidelink communications resource pool is configured for only the energy harvesting transmissions, and wherein the energy harvesting configuration is provided in a first sidelink control channel transmission that is nonspecific to energy harvesting and a second sidelink shared channel transmission that provides one or more energy harvesting parameters, or the energy harvesting configuration is provided in a first sidelink control channel transmission that is specific to energy harvesting.

16. The method of claim 1, wherein the sidelink communications resource pool includes a first subset of resources for data transmissions and a second subset of resources for the energy harvesting transmissions, and wherein each of the first subset of resources and the second subset of resources have separate channel sensing parameters, channel busy ratio (CBR) configurations, power control configurations, or any combinations thereof.

17. The method of claim 1, wherein the sidelink communications resource pool includes resources for the energy harvesting transmissions that are scheduled by a network entity or by the first UE.

18. The method of claim 1, wherein the energy harvesting transmissions are wideband transmissions that span frequency resources of one sidelink communications resource pool or two or more frequency division multiplexed sidelink communications resource pools.

19. The method of claim 1, wherein the energy harvesting transmissions use resources that at least partially overlap in time and frequency with one or more data transmissions, and wherein the energy harvesting configuration indicates one or more parameters for interference mitigation of the energy harvesting transmissions prior to decoding of the one or more data transmissions.

20. The method of claim 1, wherein one or more resources within the sidelink communications resource pool are selected for the energy harvesting transmissions by the first UE that receives the energy harvesting transmissions, by the second UE that transmits the energy harvesting transmissions, or by a network entity that configures the sidelink communications resource pool.

21. A method for wireless communication at a network entity, comprising:
identifying at least a first user equipment (UE) and a second UE for sidelink communications; and
transmitting control signaling to at least the first UE and the second UE for a sidelink communications resource pool, the control signaling including one or more energy harvesting configurations that are available for at least a portion of the sidelink communications resource pool, the one or more energy harvesting configurations indicting one or more of a waveform for energy harvesting transmissions or an energy transfer level of the energy harvesting transmissions.

22. The method of claim 21, wherein the one or more energy harvesting configurations include two or more waveforms for the energy harvesting transmissions that are selectable based at least in part on a target amount of energy to be transferred in the energy harvesting transmissions.

23. The method of claim 21, wherein the sidelink communications resource pool includes a set of sidelink resources, and wherein all resources of the set of sidelink resources are allocated for the energy harvesting transmissions or a subset of the set of sidelink resources are allocated for the energy harvesting transmissions.

24. The method of claim 21, wherein each of the one or more energy harvesting configurations indicates one or more of a charging rate, a waveform type of the energy harvesting transmissions, a portion of the sidelink communications resource pool that is allocated for the energy harvesting transmissions, or any combinations thereof.

25. An apparatus for wireless communication at a first user equipment (UE), comprising:
at least one processor; and
memory coupled with the at least one processor, the memory storing instructions executable by the at least one processor to cause the UE to:
receive control signaling for a sidelink communications resource pool, the control signaling including an energy harvesting configuration for at least a portion of the sidelink communications resource pool, the energy harvesting configuration indicting one or more of a waveform for energy harvesting transmissions or an energy transfer level of the energy harvesting transmissions;
determine, based at least in part on the energy harvesting configuration, one or more energy harvesting parameters for communications with a second UE via the sidelink communications resource pool; and
communicate with the second UE based at least in part on the one or more energy harvesting parameters.

26. The apparatus of claim 25, wherein the instructions are further executable by the at least one processor to cause the apparatus to:
receive a first sidelink communications resource pool configuration for a first resource pool in which all available resources are allocated for the energy harvesting transmissions, or in which a portion of the available resources are allocated for the energy harvesting transmissions.

27. The apparatus of claim 25, wherein the control signaling for two or more sidelink communications resource pools is provided by a network entity that configures sidelink communications between the first UE and the second UE, and wherein at least one of the two or more sidelink communications resource pools includes the energy harvesting configuration.

28. The apparatus of claim 25, wherein the instructions are further executable by the at least one processor to cause the apparatus to:
receive two or more energy harvesting configurations for the sidelink communications resource pool in a first sidelink control information communication; and
receive an indication of a selected energy harvesting configuration of the two or more energy harvesting configurations in a second sidelink control information communication, and wherein communications with the second UE are performed in accordance with the selected energy harvesting configuration.

29. An apparatus for wireless communication at a network entity, comprising:
at least one processor; and
memory coupled with the at least one processor, the memory storing instructions executable by the at least one processor to cause the network entity to:
identify at least a first user equipment (UE) and a second UE for sidelink communications; and
transmit control signaling to at least the first UE and the second UE for a sidelink communications resource pool, the control signaling including one or more energy harvesting configurations that are available for at least a portion of the sidelink communications resource pool, the one or more energy harvesting configurations indicting one or more of a waveform for energy harvesting transmissions or an energy transfer level of the energy harvesting transmissions.

30. The apparatus of claim 29, wherein the one or more energy harvesting configurations include two or more waveforms for the energy harvesting transmissions that are selectable based at least in part on a target amount of energy to be transferred in the energy harvesting transmissions.
